(19) United States
(12) Patent Application Publication
(10) Pub. No.: US 2026/0064750 A1
(43) Pub. Date: Mar. 5, 2026

(54) Content Generation With Generative AI Based on Mapping Proprietary Content to Non-Proprietary Content

(71) Applicant: Oracle International Corporation, Redwood Shores, CA (US)

(72) Inventors: John D. Clark, JR., Pepperell, MA (US); Thomas V. LeFebvre, Ridgefield, CT (US); Tim Gaumont, Mesa, AZ (US)

(73) Assignee: Oracle International Corporation, Redwood Shores, CA (US)

(21) Appl. No.: 19/187,611

(22) Filed: Apr. 23, 2025

Related U.S. Application Data
(60) Provisional application No. 63/690,649, filed on Sep. 4, 2024.

(51) Int. Cl. G06F 16/34; G06F 16/3332

(52) U.S. Cl. CPC G06F 16/34; G06F 16/3334

(57) ABSTRACT

Techniques for generating visualizations with generative artificial intelligence (AI) using enriched prompts are disclosed. A system identifies proprietary content in a request to a generative AI model. The proprietary content corresponds to content that the generative AI model is not trained on to generate outputs. The system generates an enriched prompt for the generative AI model based on a mapping of proprietary terms to non-proprietary terms and content. The enriched prompt includes content from the request, including the proprietary terms and the mapping of proprietary terms to non-proprietary terms and content. The generative AI model generates the requested visualization, including proprietary content, based on the enriched prompt.

### BENEFIT CLAIMS; RELATED APPLICATIONS; INCORPORATION BY REFERENCE

This application claims the benefit of U.S. Provisional Patent Application 63/690,649, filed Sep. 4, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to empowering generative artificial intelligence (AI) machine learning models trained on non-proprietary content to generative visualizations based on proprietary content. In particular, the present disclosure relates to providing a generative AI model with a request to generate a visualization and with mapping data that maps proprietary content in the request to non-proprietary content.

### BACKGROUND

Generative artificial intelligence (AI) models are machine learning models trained on billions of words, tokens, graphs, charts, and image data to generate natural language sentences and visualizations. Generative AI models are trained on generic data. For example, generative AI models are trained to learn common meanings of words and common relationships of words to other words. If an organization makes up a novel word to describe a metric, process, workflow, or other business entity, or uses an existing word in an unconventional way, a generative AI model will not recognize the proprietary use of the word.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1D illustrate a system in accordance with one or more embodiments;

FIGS. 2A and 2B illustrate an example set of operations for generating visualizations with generative AI using enriched prompts in accordance with one or more embodiments;

FIGS. 3A and 3B illustrate an example set of operations for training a term classification machine learning model;

FIGS. 4A-4F illustrate an example embodiment;

FIG. 5 illustrates an example set of operations for generating visualizations with generative AI using enriched prompts in accordance with one or more embodiments;

FIGS. 6A and 6B illustrate an example embodiment of generating scheduling visualizations with generative AI using enriched prompts in accordance with one or more embodiments;

FIG. 7 illustrates an example set of operations for generating visualizations with generative AI using enriched prompts in accordance with one or more embodiments;

FIGS. 8A and 8B illustrate an example embodiment of generating reconciliation visualizations with generative AI using enriched prompts in accordance with one or more embodiments; and

FIG. 9 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. GENERATIVE AI CONTENT VISUALIZATION ARCHITECTURE
3. GENERATING VISUALIZATIONS WITH GENERATIVE AI USING ENRICHED PROMPTS
4. TRAINING A TERM CLASSIFICATION MACHINE LEARNING MODEL
5. EXAMPLE EMBODIMENT
6. GENERATING SCHEDULING VISUALIZATIONS WITH GENERATIVE AI USING ENRICHED PROMPTS
7. GENERATING RECONCILIATION VISUALIZATIONS WITH GENERATIVE AI USING ENRICHED PROMPTS
8. COMPUTER NETWORKS AND CLOUD NETWORKS
9. HARDWARE OVERVIEW
10. MISCELLANEOUS; EXTENSIONS

### 1. General Overview

Generative AI models are trained with large volumes of data of different types, in the order of billions of words, text segments, image content, and graphics content. Generative AI training datasets either do not include proprietary content, or the proprietary content is too scarce to train the generative AI models to generate visualizations referencing the proprietary content. For example, a small company may manufacture a vehicle named Grizzly. A generative AI prompt instructing the generative AI to chart growth estimates for the Grizzly over the next three years may result in the generative AI generating a chart for a non-proprietary term, grizzly bears.

One or more embodiments generate enriched prompts for generative artificial intelligence (AI) models to generate visualizations referencing proprietary content. The system generates enriched prompts that empower the generative AI to generate visualizations for proprietary terms and content by combining patterns learned by the generative AI model in training on non-proprietary visualizations with mappings of proprietary terms to non-proprietary terms.

A system generates an enriched prompt instructing a generative AI model to generate a visualization referencing proprietary content. The enriched prompt includes (a) a request including proprietary content and (b) mapping data that specifies non-proprietary content corresponding to the proprietary content. The enriched prompt may also include location data specifying a location of proprietary values associated with the proprietary content. For example, a system may generate an enriched prompt that includes a mapping of the proprietary term “Grizzly” to the non-proprietary terms “offroad,” “vehicle,” “4×4,” and “4 seat.” Based on the mapping, the generative AI model generates a visualization based on learned patterns associated with non-proprietary, offroad, 4×4 four-seater vehicles. The enriched prompt further includes a location in digital memory for obtaining proprietary data. In the above example, the prompt may include a link to a file that includes past sales data for the Grizzly offroad vehicle. The file may include data that was not included in the training data sets for training the generative AI model. The generative AI model combines learned patterns from being trained on non-proprietary data sets with the mapping data for the proprietary term “Grizzly” to generate a visualization that includes values based on the proprietary values for the Grizzly.

One or more embodiments apply a semantic analysis machine learning model to identify proprietary terms in a request to a generative AI model. Some terms may have both proprietary and non-proprietary meanings. For example, a request to generate a table comparing Gold accounts to Silver accounts includes proprietary terms “Gold” and “Silver.” The semantic analysis machine learning model is trained on proprietary data to distinguish between the use of the terms gold and silver as proprietary terms referring to categories of accounts managed by an organization and non-proprietary types of metals. In one embodiment, based on identifying proprietary terms in a set of generative AI instructions, the system accesses a mapping table or dictionary to determine if the proprietary terms are included in the mapping table or dictionary. If so, the system generates an enriched prompt to the generative AI model that includes the instructions and the mapping data obtained from the mapping table or dictionary. If the system determines the proprietary terms are not included in the mapping table or dictionary, the system adds the proprietary terms to the mapping table or dictionary. The system further parses proprietary content stored by an organization to extract mapping data for the proprietary terms. For example, the system may identify a non-proprietary product type associated with a proprietary name. The system stores the mapping data in the mapping table or dictionary.

One or more embodiments generate enriched prompts for generative AI models to generate scheduling visualizations referencing proprietary scheduling content. The system generates enriched prompts that empower the generative AI to generate scheduling visualizations for proprietary terms and content by combining patterns learned by the generative AI model in training on non-proprietary visualizations with mappings of proprietary scheduling terms to non-proprietary terms. For example, a system may receive a request for a generative AI model to generate visualizations of actual versus planned completed tasks, tasks scheduled over time, and tasks completed by region. The system maps non-proprietary task schedule visualizations to proprietary task data, such as data maintained within a company that is not available outside the company.

In addition to mapping non-proprietary task schedule visualizations to proprietary task data, the system may identify proprietary terms in the request to the generative AI model. For example, a request may include instructions to generate a visualization of completion rates of Type I tasks versus Type II tasks. The system may identify the terms Type I and Type II as proprietary terms for tasks. The system may access a mapping table that maps the term “Type I” to tasks associated with a project named Project Alpha, and the term “Type II” to tasks associated with projects named Project Beta and Project Gamma in a company's proprietary datastore. As another example, the system may identify a proprietary term describing a type of visualization, such as a “Director's Graph.” The system may obtain a mapping of the term “Director's Graph” to (a) a bar graph, and (b) a set of task types to display in the bar graph. For example, the mapping may specify the bar graph presents a representation of tasks classified as urgent in a system that have been completed over a 7-day period and a set of tasks identified as urgent that are still open. In some embodiments, identifying the proprietary term associated with the visualization results in the system obtaining one or more example or historical graphs associated with the proprietary term. The generative AI model generates a scheduling visualization based on the mapping of proprietary terms to content, such as content stored by an organization and/or non-proprietary terms.

One or more embodiments generate enriched prompts for generative AI models to generate reconciliation visualizations referencing proprietary reconciliation content. The system generates enriched prompts that empower the generative AI to generate reconciliation visualizations for proprietary terms and content by combining patterns learned by the generative AI model in training on non-proprietary visualizations with mappings of proprietary reconciliation terms to non-proprietary terms. For example, a system may receive a request for a generative AI model to generate visualizations of open reconciliations by account types. The system maps non-proprietary reconciliation visualizations to proprietary task data, such as data maintained within a company that is not available outside the company.

In addition to mapping non-proprietary task schedule visualizations to proprietary task data, the system may identify proprietary terms in the request to the generative AI model.

For example, a request may include instructions to generate a visualization of open reconciliations for Tier I accounts. The system may identify the term Tier I as proprietary term describing a type of account. The system may access a mapping table that maps the term “Tier I” to a set of accounts maintained by a company. As another example, the system may identify a proprietary term describing a type of visualization, such as a “Monthly Reconciliation Report.” The system may obtain a mapping of the term “Monthly Reconciliation Report” to a set of reconciliation graphs including (a) a bar graph illustrating a burndown chart, (b) a pie graph illustrating reconciliations by account, and (c) a bar graph showing total reconciliation amounts by time period. In some embodiments, identifying the proprietary term associated with the visualization results in the system obtaining one or more example or historical graphs associated with the proprietary term. For example, the system may obtain a historical example of a monthly reconciliation report including the specified graphs. The generative AI model generates a reconciliation visualization based on the mapping of proprietary terms to content, such as content stored by an organization and/or non-proprietary terms.

One or more embodiments described in this Specification and/or recited in the claims may not be included in this General Overview section.

### 2. Generative AI Content Visualization Architecture

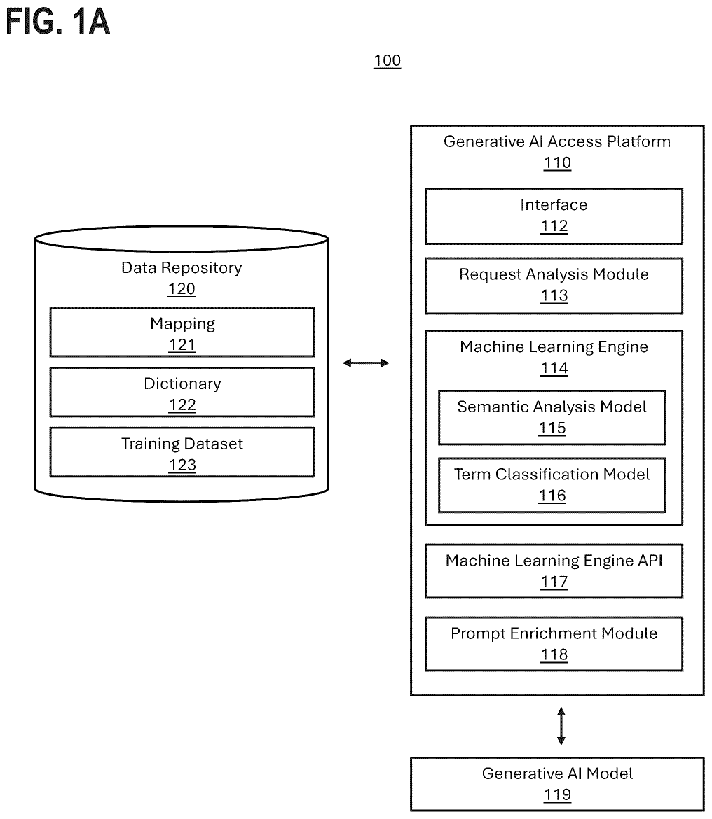

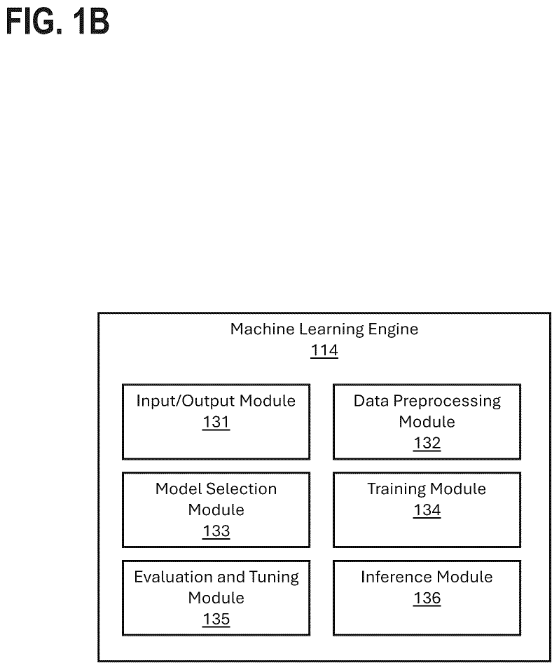

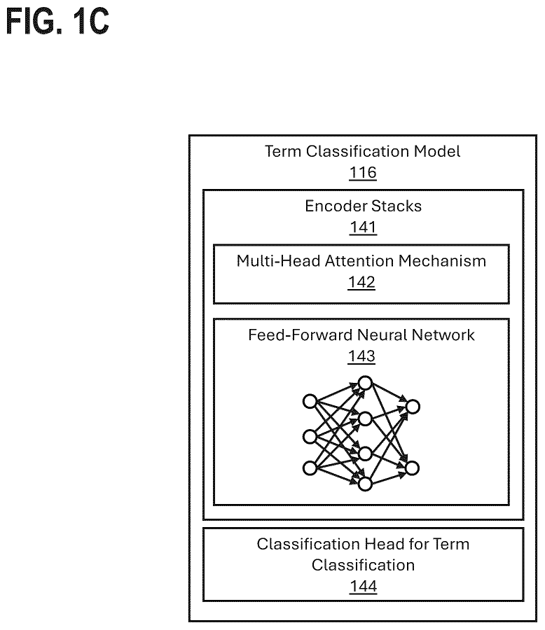

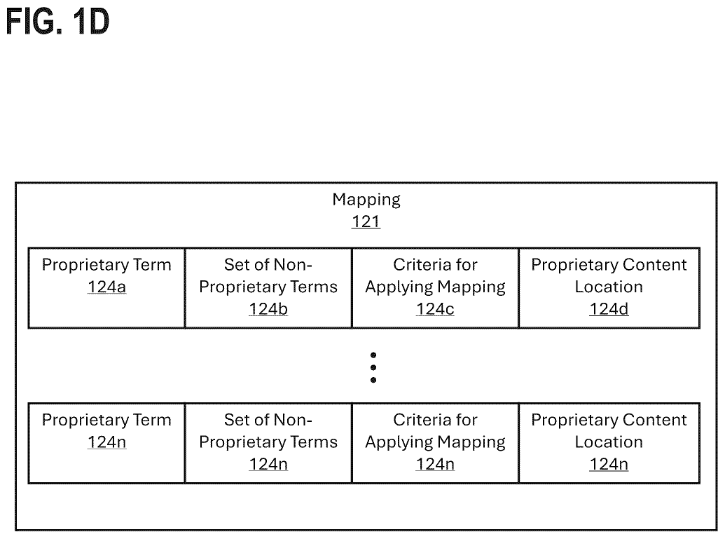

FIGS. 1A-1D illustrate a system 100 in accordance with one or more embodiments. As illustrated in FIG. 1A, system 100 includes a generative AI access platform 110, a data repository 120, and a generative AI model 119. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

In one or more embodiments, a data repository 120 is any type of storage unit and/or device (e.g., a file system, database, collection of tables, or any other storage mechanism) for storing data. Furthermore, a data repository 120 may include multiple different storage units and/or devices. The multiple different storage units and/or devices may or may not be of the same type or located at the same physical site. Furthermore, a data repository 120 may be implemented or executed on the same computing system as the generative AI access platform 110. Additionally, or alternatively, a data repository 120 may be implemented or executed on a computing system separate from the generative AI access platform 110. The data repository 120 may be communicatively coupled to the generative AI access platform 110 via a direct connection or via a network.

Information describing a mapping 121, a dictionary 122, and a training dataset 123 may be implemented across any components within the system 100. However, this information is illustrated within the data repository 120 for purposes of clarity and explanation.

The generative AI access platform 110 includes an interface 112. The interface 112 allows a user to interact with the generative AI access platform 110 to generate requests to the generative AI model 119 and to observe results based on content generated by the generative AI model 119. In one or more embodiments, interface 112 refers to hardware and/or software configured to facilitate communications between a user and the generative AI access platform 110. Interface 112 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 112 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 112 is specified in one or more other languages, such as Java, C, or C++.

The generative AI access platform 110 provides users with access to the generative AI model 119. The interface 112 may include the GUI that allows a user to generate a request to the generative AI model 119. For example, a user may type a sentence into a text entry field to request that the generative AI model 119 generate content. The generative AI access platform 110 selectively modifies requests prior to transmitting the requests to the generative AI model 119 to improve the responsiveness of the generative AI model 119 to the requests.

A request analysis module 113 analyzes content of the requests. Analyzing content includes parsing the request to identify terms in the request. The request analysis module 113 classifies terms in the request as proprietary terms or non-proprietary terms. In one embodiment, the request analysis module 113 applies a semantic analysis model 115 to the request to analyze the terms in the request. Additionally, or alternatively, the request analysis module 113 may apply a term classification model 116 to the request to classify terms in the request as being proprietary terms or non-proprietary terms. Additionally, or alternatively, proprietary terms include terms that are used by an entity or organization that are not in wide use in a general vocabulary. Specifically, the generative AI model 119 is trained with large volumes of data of diverse types, in the order of billions of words, text segments, image content, and graphics content. Non-proprietary terms, as used herein, refers to terms that are used sufficiently widely such that the generative AI model is capable of generating an output responsive to the non-proprietary meaning of the terms when a prompt includes the terms. Proprietary terms, as used herein, refer to terms that are either (a) not included in the training dataset for the generative AI model or (b) included with insufficient frequency to train the model as to the meaning of the terms. In other words, when a request to the generative AI model includes proprietary terms, the generative AI model is incapable of generating a response that takes into account the meaning of the proprietary terms. In some examples, a proprietary term may also have a non-proprietary meaning. As used herein, the generative AI model may be trained to generate a response based on the non-proprietary meaning. The model may be trained as to be incapable of generating a response that captures the proprietary meaning.

A machine learning engine 114 trains one, or both, of the semantic analysis model 115 and the term classification model 116. In some embodiments, the machine learning engine 114 generates the term classification model 116 by adding a classification head onto an output layer of the semantic analysis model 115. In one or more embodiments, the machine learning engine employs a machine learning algorithm to train the semantic analysis model 115 and the term classification model 116. The machine learning algorithm is an algorithm that can be iterated to train a target model f that best maps a set of input variables to an output variable, using a set of training data, including the training dataset 123. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

FIG. 1B illustrates an example of a machine learning engine 114. As illustrated in FIG. 1B, machine learning engine 114 includes input/output module 131, data preprocessing module 132, model selection module 133, training module 134, evaluation and tuning module 135, and inference module 136.

In accordance with an embodiment, input/output module 131 serves as the primary interface for data entering and exiting the system, managing the flow and integrity of data. This module may accommodate a wide range of data sources and formats to facilitate integration and communication within the machine learning architecture.

In an embodiment, an input handler within input/output module 131 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 131 to be versatile in different operational contexts, whether processing historical datasets or streaming data.

In accordance with an embodiment, input/output module 131 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 131 includes an output framework designed to handle the distribution and exportation of outputs, predictions, or insights. Using the output framework, input/output module 131 formats these outputs into user-friendly and accessible formats, such as reports, visualizations, or data files compatible with other systems. Input/output module 131 also ensures secure and efficient transmission of these outputs to end-users or other systems in an embodiment and may employ encryption and secure data transfer protocols to maintain data confidentiality.

In accordance with an embodiment, data preprocessing module 132 transforms data into a format suitable for use by other modules in machine learning engine 114. For example, data preprocessing module 132 may transform raw data into a normalized or standardized format suitable for training ML models and for processing new data inputs for inference. In an embodiment, data preprocessing module 132 acts as a bridge between the raw data sources and the analytical capabilities of machine learning engine 114.

In an embodiment, data preprocessing module 132 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 132 may be configured to handle anomalies in different ways depending on context. Data preprocessing module 132 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 132 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 132 processes new data for inference, data preprocessing module 132 replicates the same preprocessing steps to ensure consistency with the training data format. This helps to avoid discrepancies between the training data format and the inference data format, thereby reducing the likelihood of inaccurate or invalid model predictions.

In an embodiment, model selection module 133 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 133 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 133 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 133 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 133 also considers computational efficiency and resource constraints. This is meant to help ensure the selected model is both accurate and practical in terms of computational and time requirements. In an embodiment, certain features of model selection module 133 are configurable such as a configured bias toward (or against) computational efficiency.

In accordance with an embodiment, training module 134 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 134 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 134 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 134 includes logic to handle different types of data and learning tasks. For instance, it includes different training routines for supervised learning (where the training data comes with labels) and unsupervised learning (without labeled data). In the case of deep learning models, training module 134 also manages the complexities of training neural networks that include initializing network weights, choosing activation functions, and setting up neural network layers.

In an embodiment, evaluation, and tuning module 135 incorporates dynamic feedback mechanisms and facilitates continuous model evolution to help ensure the system's relevance and accuracy as the data landscape changes. Evaluation and tuning module 135 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation, and tuning module 135 performs continuous model tuning by using hyperparameter optimization. Evaluation and tuning module 135 performs an exploration of the hyperparameter space using algorithms, such as grid search, random search, or more sophisticated methods like Bayesian optimization. Evaluation and tuning module 135 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation, and tuning module 135 integrates data feedback and updates the model. Evaluation and tuning module 135 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 135 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 135 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 136 transforms data raw data into actionable, precise, and contextually relevant predictions. In addition to processing and applying a trained model to new data, inference module 136 may also include post-processing logic that refines the raw outputs of the model into meaningful insights.

In an embodiment, inference module 136 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 136 transforms the outputs of a trained model into definitive classifications. Inference module 136 employs the underlying model as a tool to generate probabilistic outputs for each potential class. It then engages in an interpretative process to convert these probabilities into concrete class labels.

In an embodiment, when inference module 136 receives the probabilistic outputs from the model, it analyzes these probabilities to determine how they are distributed across some or every potential class. If the highest probability is not significantly greater than the others, inference module 136 may determine that there is ambiguity or interpret this as a lack of confidence displayed by the model.

In an embodiment, inference module 136 uses thresholding techniques for applications where making a definitive decision based on the highest probability might not suffice due to the critical nature of the decision. In such cases, inference module 136 assesses if the highest probability surpasses a certain confidence threshold that is predetermined based on the specific requirements of the application. If the probabilities do not meet this threshold, inference module 136 may flag the result as uncertain or defer the decision to a human expert.

Inference module 136 dynamically adjusts the decision thresholds based on the sensitivity and specificity requirements of the application, subject to calibration for balancing the trade-offs between false positives and false negatives.

In accordance with an embodiment, inference module 136 contextualizes the probability distribution against the backdrop of the specific application. This involves a comparative analysis, especially in instances where multiple classes have similar probability scores, to deduce the most plausible classification. In an embodiment, inference module 136 may incorporate additional decision-making rules or contextual information to guide this analysis, ensuring that the classification aligns with the practical and contextual nuances of the application.

In regression models, where the outputs are continuous values, inference module 136 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 136 incorporates domain-specific adjustments into its post-processing routine. This involves tailoring the model's output to align with specific industry knowledge or contextual information. For example, in financial forecasting, inference module 136 may adjust predictions based on current market trends, economic indicators, or recent significant events, ensuring that the outputs are both statistically accurate and practically relevant.

In an embodiment, inference module 136 includes logic to handle uncertainty and ambiguity in the model's predictions. In cases where inference module 136 outputs a measure of uncertainty, such as in Bayesian inference models, inference module 136 interprets these uncertainty measures by converting probabilistic distributions or confidence intervals into a format that can be easily understood and acted upon. This provides users with both a prediction and an insight into the confidence level of that prediction. In an embodiment, inference module 136 includes mechanisms for involving human oversight or integrating the instance into a feedback loop for subsequent analysis and model refinement.

In an embodiment, inference module 136 formats the final predictions for end-user consumption. Predictions are converted into visualizations, user-friendly reports, or interactive interfaces. In some systems, like recommendation engines, inference module 136 also integrates feedback mechanisms, where user responses to the predictions are used to continually refine and improve the model, creating a dynamic, self-improving system.

Referring to FIG. 1A, in an embodiment, machine learning engine API 117 allows for applications to leverage machine learning engine 114. In an embodiment, machine learning engine API 117 may be built on a RESTful architecture and offer stateless interactions over standard HTTP/HTTPS protocols. Machine learning engine API 117 may feature a variety of endpoints, each tailored to a specific function within machine learning engine 114. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 117 is equipped to support SOAP-based interactions. This extension involves defining a WSDL (Web Services Description Language) document that outlines the API's operations and the structure of request and response messages. In an embodiment, machine learning engine API 117 supports various data formats and communication styles. In an embodiment, machine learning engine API 117 endpoints may handle requests in JSON format or any other suitable format. For example, machine learning engine API 117 may process XML, and it may also be engineered to handle more compact and efficient data formats, such as Protocol Buffers or Avro, for use in bandwidth-limited scenarios.

In an embodiment, machine learning engine API 117 is designed to integrate WebSocket technology for applications necessitating real-time data processing and immediate feedback. This integration enables a continuous, bi-directional communication channel for a dynamic and interactive data exchange between the application and machine learning engine 114.

The machine learning engine 114 trains the semantic analysis model 115 to generate semantic encodings for terms in a request. The machine learning engine 114 trains the term classification model 116 to classify terms in a request as proprietary terms or non-proprietary terms. In addition, where a term includes proprietary and non-proprietary meanings, the machine learning engine 114 trains the term classification model 116 to classify the term based on the meaning associated with the request. In an embodiment, training the term classification model 116 includes adding a classification head onto an output layer of the semantic analysis model 115.

FIG. 1C illustrates the term classification model 116 according to an embodiment. The term classification model 116 includes a set of encoder stacks 141. Each encoder stack in the set of encoder stacks 141 includes a multi-head attention mechanism 142 and a feed-forward neural network 143. In one embodiment, the semantic analysis model 115 is embodied as the set of encoder stacks 141. The term classification model 116 further comprises a classification head 144 for generating term classifications.

The encoders in the set of encoder stacks 141 include multi-attention heads 142 that provide a self-attention mechanism. The attention mechanism dynamically determines weights for elements of input tokens of an input vector based on input queries and element keys. The result of the attention mechanism is a combined representation of an input sequence. The term classification model 116 generates the combined representation by concatenating the outputs from multiple attention heads, where each attention head focuses on distinct aspects of the input sequence. The term classification model 116 then applies a linear transformation to the concatenated output. The multi-attention head 142 allows the encoder 141 to simultaneously focus on different aspects of an input sequence by running multiple independent attention mechanisms (i.e., “heads”) in parallel. Focusing on distinct aspects of the set of input elements allows the encoder 141 to encode embeddings representing input data with additional data representing relationships between elements within the set of input data elements.

The feed-forward neural network 143 converts the output from the multi-head attention mechanism 142 into a set of output sequences that include a word vector embedding sequence and a positional encoder sequence. The word vector embeddings are numerical representations of text. The positional encoding sequence represents the relative positions of words in the word vector embedding sequence. Each sub-layer of the encoder stacks 141 receives an output from the previous sub-layer and applies the attention mechanism 142 and neural network 143 to the output from the previous sub-layer to generate a new output embedding representing the input sequence.

The term classification model 116 includes a classification head 144 for classifying terms in a request to a generative AI model. In practice, the semantic analysis model 115 may be embodied as an encoder-type machine learning model such as the encoder stacks 141. The semantic analysis model 115 outputs an embedding that represents semantic data for a term. The classification head 144 receives the embedding as an input. The classification head 144 generates an output classifying the term as a proprietary term or a non-proprietary term. Additionally, when a term includes both proprietary and non-proprietary meanings, the classification head 144 generates an output specifying whether the use of the term in the request corresponds to a proprietary meaning or a non-proprietary meaning.

In one embodiment, one or more final layers of the final encoder stack among the encoder stacks 141 is removed. A new set of neural layers is added to the final, feed-forward neural network 143. The term classification model 116 is then re-trained on a dataset including (a) historical datasets of request data and (b) historical classifications of terms in the historical requests. However, in retraining the model, each neural layer of each neural network 143, other than the classification head 144, is frozen. In other words, the model maintains constant the parameters (e.g., offsets and weights) of the neurons in the neural network 143 other than the parameters of the neurons in the classification head 144.

Based on the term classifications generated by the request analysis module 113, including the term classification model 116, a prompt enrichment module 118 generates an enriched generative AI prompt. The enriched generative AI prompt includes (a) content from the request to the generative AI model 119 and (b) additional content to allow the generative AI model 119 to generate a visualization based on proprietary terms. In one embodiment, the prompt enrichment module 118 obtains a mapping 121. The mapping specifies proprietary terms and corresponding non-proprietary terms.

FIG. 1D illustrates a mapping 121 according to an embodiment. The mapping 121 includes proprietary terms 124a-124n. For each proprietary term 124a-124n, the mapping may include (a) sets of non-proprietary terms 124b-124n, criteria for applying the mapping 124c-124n, and (d) proprietary content locations 124d-124n. Sets of non-proprietary terms 124b-124n include synonyms and other non-proprietary terms that describe proprietary terms. For example, if a proprietary term is “Grizzly,” the mapping 121 may store a non-proprietary word “truck” that describes the type of vehicle that the proprietary term names. If a proprietary term is “Star Chart,” the set of non-proprietary terms may include a description of what the star chart looks like—“a diagram shaped like a star, with the top five performing salespeople in Division X named at the points of the star. Inside the star is a combined value of the sales this month of the first top performing salespeople.”

Criteria for applying the mapping 124c-124n specify conditions when to apply and when to refrain from applying a mapping. For example, the system may generate a visualization based on a mapping of a proprietary term to a non-proprietary term. A user may provide feedback to not apply the mapping. The system may store the request and an instruction to not apply the mapping in the criteria for applying mapping field of the mapping 121. Additionally, a user may provide a reason to refrain from applying the mapping, such as “Don't generate a proprietary Sun Diagram unless the request includes the term ‘sales’.” Similarly, the system may generate a visualization without providing a mapping in a generative AI prompt. A user may provide feedback to apply a mapping. For example, the user may specify, “On the last day of the month, a request including ‘performance metrics’ should include a bar graph presenting unit efficiency data for Department X.” If it does not already exist, the system may store the mapping of “performance metrics” to “bar graph; efficiency; department X.” The system may further store in the criteria for applying mapping field 124c the criteria “last day of the month.”

The mapping 121 may further include location data for proprietary content location 124d-124n. For example, the field 124a may store a link to direct the prompt enrichment module 118 to a location in memory storing proprietary data, such as sales data, inventory data, and organization hierarchy data. A generative AI model 119 may use the proprietary data to generate a visualization.

In some embodiments, the prompt enrichment module 118 generates an enriched prompt using a dictionary 122. The dictionary 122 may provide definitions that use non-proprietary terms for corresponding proprietary terms.

The generative AI model 119 generates a visualization based on an enriched prompt generated by the prompt enrichment module 118. The enriched prompt is enriched with at least a mapping 121 of proprietary content to non-proprietary content. A generative model is a machine learning model that is capable of generating new data instances based on the data used to train the model. In the present specification, a generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, like unsupervised learning, semi-supervised learning, and domain adaptation.

One type of generative model is a large language model (LLM). Large language models (LLMs) are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times. In one embodiment, the generative AI model 119 is an LLM.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data.

The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 131, when used for LLMs, handles textual data, converting input text into a format that the model can process. This typically involves tokenization, where the text is broken down into manageable pieces, such as words or sub-words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 132 in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 133, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 134, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 135 assesses the performance of LLMs using various metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 136, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

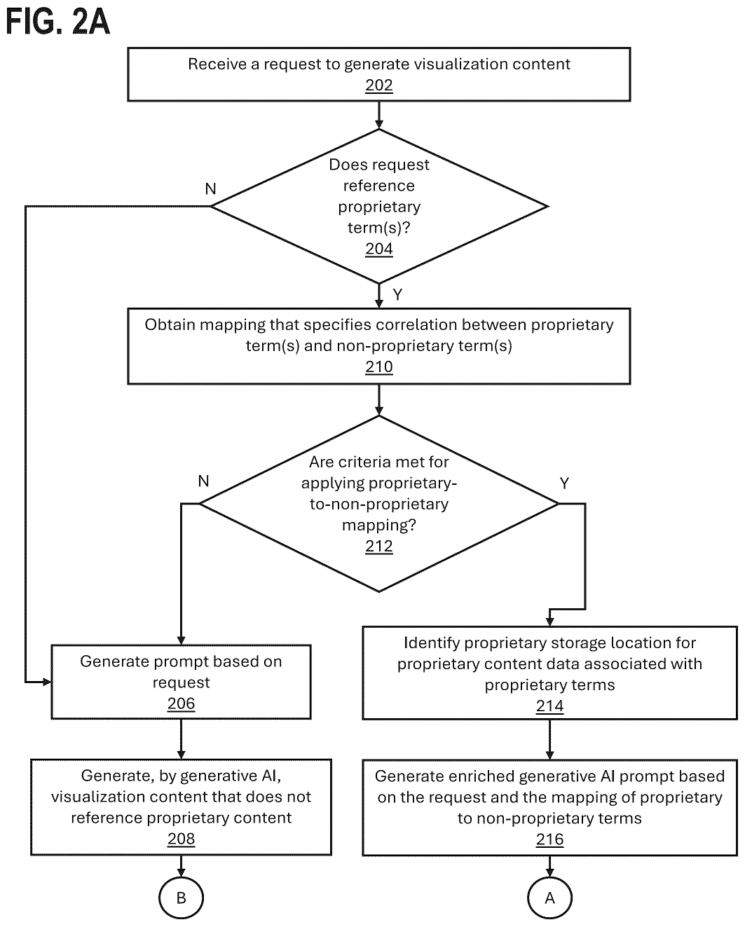

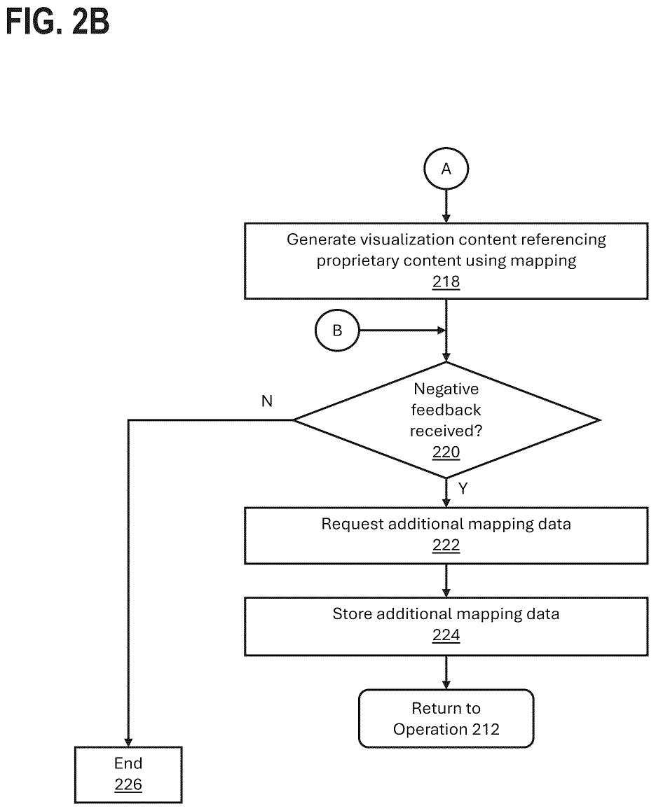

In one or more embodiments, a generative AI access platform 110 refers to hardware and/or software configured to perform operations described herein for generating enriched generative AI prompts to allow a generative AI model to generate visualizations using proprietary content. Examples of operations for generating visualizations with a generative AI model using enriched prompts are described below with reference to FIGS. 2A and 2B.

In an embodiment, the generative AI access platform 110 is implemented on one or more digital devices. The term “digital device” refers to any hardware device that includes a processor. A digital device may refer to a physical device executing an application or a virtual machine. Examples of digital devices include a computer, a tablet, a laptop, a desktop, a server, and a mainframe.
3. Generating Visualizations with Generative AI using Enriched Prompts

FIGS. 2A and 2B illustrate an example set of operations for generating visualizations with generative AI using enriched prompts in accordance with one or more embodiments. One or more operations illustrated in FIGS. 2A and 2B may be modified, rearranged, or omitted. Accordingly, the sequence of operations illustrated in FIGS. 2A and 2B should not be construed as limiting the scope of one or more embodiments.

Referring to FIG. 2A, a system receives a request to generate visualization content (Operation 202). The visualization may be a chart, a graph, or other image. In some embodiments, the instructions are in the form of a natural language request directed to a generative AI model. For example, a user may enter words and symbols into a field that is used to generate prompts for a generative AI model. The system may receive and process the request before determining whether or not to modify the content in the request prior to passing the instruction to the generative AI model.

The system determines if the request includes proprietary content (Operation 204). Proprietary content includes terms used within an organization that are not commonly used outside the organization. For example, an organization may use proprietary terms for products under development, for applications used by the organization, for positions within the organization, for visualizations of content, and/or for metrics that measure performance of employees, systems, manufacturing processes, workflows, and sales in the organization.

For example, an organization may use the terms “pebble,” “boulder,” and “mountain” to describe categories of customer service issues. Within the organization, a “pebble” may refer to a small and easily resolved issue, while a “mountain” refers to a challenging issue requiring significant resources to address. As another example, a company may have a product called the “Grizzly” under production. As another example, a company may use the term “Gold” to refer to accounts that have been reconciled without errors, “Red” to refer to accounts that have been reconciled with errors, and “Gray” to refer to accounts that have not been reconciled. A user requesting a visualization may enter the terms “generate a chart showing the ratio of Gold, Red, and Gray accounts for the last financial quarter.” According to another example, an entity may use a proprietary name, “Excellence-o-meter,” to refer to a visualization or graphic. Outside the company, the chart may have a different name such as “gauge graph.”

The system may include a generative AI screening platform that screens user-generated instructions to the generative AI model to identify proprietary terms that have one meaning within an organization and a different meaning, or no meaning, outside the organization. The generative AI screening platform may be interposed between a user interface component in a system and the generative AI model. The generative AI access platform 110 represented in FIG. 1A is an example of a generative AI screening platform. For example, a user may enter content into a field with the intent to transmit the content to the generative AI model to generate a visualization. The generative AI screening platform intercepts the content, or request, prior to transmitting the request to the generative AI model. The generative AI screening platform may store reference tables to proprietary terms for an organization. The system may retrieve and parse proprietary data sets to identify the proprietary terms.

In an embodiment, the system determines if a request includes proprietary content by comparing terms, tokens, and phrases in the request with a mapping and/or a dictionary of proprietary terms, tokens, and phrases. A system may store a mapping of identified proprietary terms and phrases. The mapping may include non-proprietary terms and/or phrases that correspond to the proprietary terms and phrases. The system may determine that the request includes a proprietary term or phrase when the term or phrase is present among the proprietary terms and phrases in the mapping.

Similarly, a system may maintain a dictionary of proprietary terms and phrases as well as corresponding non-proprietary definitions of the proprietary terms and phrases. The system may determine that the request includes a proprietary term or phrase when the term or phrase is present among the proprietary terms and phrases in the dictionary.

One or more embodiments employ a trained machine learning model to analyze received instructions to determine if terms are proprietary or non-proprietary. For example, a term may have one meaning within an organization and another meaning outside the organization. The system may provide a set of instructions to a semantic analysis type machine learning model to determine if the terms included in the instructions refer to proprietary content or non-proprietary content. Examples of semantic analysis models that may be used include Word2Vec, Global Vectors for Word Representation (GloVe), and Bidirectional Encoder Representations from Transformers (BERT).

One or more embodiments employ a hybrid approach to determining whether a request includes proprietary terms and/or phrases. The hybrid approach includes (a) comparing terms and phrases in the request to a mapping and (b) applying a trained machine learning model to the request to identify proprietary terms and phrases that are not included in the mapping. The system may apply the hybrid approach sequentially. The system may first compare terms and phrases in the request to the mapping to determine if the terms and phrases are included as proprietary terms or phrases in the mapping. If the system determines the terms or phrases are included in the mapping, the system may refrain from applying the trained machine learning model. However, if the system fails to identify terms or phrases from the request in the mapping, the system may apply the trained machine learning model to determine whether proprietary terms or phrases are included in the request that are not yet included in the mapping.

If the system determines the request does not include proprietary content, the system generates a prompt based on the request (Operation 206). The system may pass the request on to the generative AI without modifying the request. Alternatively, the system may modify the request to include structural elements for the generative AI prompt. For example, the system may add context data specifying a tone to apply to a generative AI output, colors to include in the generative AI output, and a format or file type of the visualization.

Based on the prompt, the generative AI generates visualization content (Operation 208). The visualization is based on the patterns learned by the generative AI during training on the non-proprietary training data and any modifications to the request included in the prompt. Since the training data does not include proprietary content or does not include sufficient proprietary content to train the generative AI to generate output data referencing proprietary content, the visualization does not include proprietary content. In some examples where a term may have both a proprietary meaning and a non-proprietary meaning, the generative AI model generates a visualization based on the non-proprietary meaning.

If the system determines that the request includes proprietary content, the system obtains mapping data that specifies relationships between proprietary content and non-proprietary content (Operation 210). Mapping data includes a mapping of proprietary terms to non-proprietary terms. The mapping data may further include a description or definition of a proprietary term. The mapping data may further include a location where a system may go to retrieve data for generating a visualization based on the proprietary content.

For example, a request entered into a field in a GUI may include “generate a story based on [content X].” An organization may use the term “story” in a proprietary context in a way that is distinct from the non-proprietary use of the term. The organization may refer to a set of related tables used in a data management platform as a “Story.” The system obtains mapping data that includes a mapping of the proprietary term “Story” to the non-proprietary terms “set of tables.”

The mapping data may further include conditions. The conditions may tell the generative AI model whether the word(s) included in the request should be interpreted as proprietary content or non-proprietary content. For example, the mapping data may include a condition: “When [content X] specifies [data type Y], apply mapping of proprietary term to non-proprietary term. When [content X] specifies [data type Z], refrain from applying the mapping and use non-proprietary term.” When the system receives feedback (described below) associated with visualizations, the system may store the feedback as conditions to be applied to future requests that include a proprietary term.

Mapping data may also include attributes and characteristics. For example, a company may develop an offroad vehicle named “Grizzly.” Mapping data may include non-proprietary data describing the Grizzly, such as “4×4”, “offroad,” “vehicle”, and “4-seater.”

In one embodiment, the system stores a dictionary of proprietary terms, mapping data associated with the proprietary terms, and conditions for determining when to apply the mapping of proprietary terms to non-proprietary terms. Additionally, or alternatively, the system may parse proprietary content to identify mapping data. For example, a machine-learning model may identify a proprietary term in a request directed to a generative AI model. The system may refer to a dictionary to determine if the proprietary term is in the dictionary. If the term is in the dictionary, the system obtains a set of mapping data associated with the proprietary term from the dictionary. However, if the term is not in the dictionary, the system accesses proprietary data sets to extract mapping data. The system may present a request to a user in a GUI for a data storage location from where the system may extract the mapping data. The system may use a semantic analysis machine learning model to identify terms in the proprietary data that describe and/or define the proprietary term. In one embodiment, the system adds the new proprietary term and corresponding mapping data to the dictionary.

In one embodiment, a generative AI screening platform interposed between a user interface and a generative AI model accesses a set of proprietary data maintained by an entity to determine correlations between proprietary and non-proprietary concepts and terms. Proprietary data may include, for example, a listing of products offered by an entity. The products may include product descriptions. Based on the product descriptions, the generative AI screening platform may determine a non-proprietary product type. The generative AI screening platform may then map the non-proprietary product type to the proprietary term included in the request to the generative AI model.

As another example, proprietary data may include employee data such as employee profile data. For example, a proprietary term may be an entity's name for an employee's position in a company such as “Explorer.” The generative AI screening platform may determine from the employee profile data that the “Explorer” position corresponds to the non-proprietary term “Product Developer.” The generative AI screening platform may make the determination based on organization structure data. Additionally, or alternatively, the generative AI screening platform may make the determination by applying the semantic machine learning model to a description of the position “Explorer”to determine the non-proprietary term for the position.

According to another example, the system may compare an example corresponding to a proprietary term with non-proprietary examples to identify a relationship of a proprietary term to a non-proprietary term. For example, the system may identify the term “sales-o-meter” as a proprietary term in a request to a generative AI model. The system may identify, in an entity's stored proprietary data, an image of a gauge graph corresponding to the description “sales-o-meter.” The system may determine the proprietary term “sales-o-meter” corresponds to the non-proprietary term gauge graph.

The system determines if criteria are met to apply a mapping of a proprietary term to a non-proprietary term (Operation 212). Determining if the criteria are met may include analyzing the textual context of a term. For example, a request may include the words “generate a line graph showing the performance of silver and gold accounts.” The system may identify Silver and Gold proprietary terms within an organization that describe types of accounts maintained by the organization. The system may determine that the mapping of the terms “Silver” and “Gold” to proprietary content is conditional on the terms being used to describe accounts and customers. The system determines from the context of the request that the request is for particular types of accounts. Accordingly, the system applies the mapping of the proprietary terms to a non-proprietary term “account.” The mapping may further specify where the system should go to obtain information about the performance of the accounts.

If the criteria are not met to apply a non-proprietary to proprietary mapping, the system proceeds to Operation 206 to generate a prompt based on the request, using the non-proprietary meaning of the terms. Referring to the example above where “Silver” and “Gold” refer to types of accounts maintained by an organization, a request may include the terms “generate a bar graph of the price of gold for the past year.” The system determines that the term “gold” is not associated with accounts or customers but rather with the metal. Accordingly, the system generates the prompt to the generative AI model without mapping the term “gold” to a non-proprietary term “account” and enriches the prompt with proprietary contextual data in the prompt.

In one embodiment, determining if criteria are met to apply a mapping of proprietary terms to non-proprietary may be based on specified criteria such as the criteria 124c-124n stored in the mapping 121 represented in FIG. 1D. These criteria may include whether specified terms are used in the same request as the proprietary term or the identity of a user initiating a request. For example, if the system determines a user generating a request is not included in a set of criteria for applying a mapping, the system may execute the request without generating an enriched prompt including the mapping of proprietary terms to non-proprietary terms. If the system determines a user generating a request is included in a set of criteria for applying the mapping, the system may execute the request by generating an enriched prompt including the mapping of proprietary terms to non-proprietary terms.

In another embodiment, determining if criteria are met to apply a mapping may be based on the output from a semantic machine learning model such as the semantic analysis model 115 represented in FIG. 1A. The semantic analysis model 115 may generate an embedding for tokens in a request. The embedding may include information representing whether or not to apply a mapping of proprietary terms to non-proprietary terms. Additionally, or alternatively, determining if criteria are met to apply a mapping may be based on the output from a classification-type machine learning model, such as the term classification model 116, represented in FIG. 1A. The system may be configured to apply a proprietary-to-non-proprietary mapping when the term classification model 116 classifies a term as “proprietary.”

If the system determines that criteria are met to apply a mapping of proprietary terms to non-proprietary terms, the system further identifies a proprietary storage location for proprietary content data (Operation 214). For example, if the proprietary term corresponds to a product, the system identifies data sets associated with the product. If the proprietary term is a term used in business workflows, the system identifies the business workflows that reference the term. If the proprietary term is a metric measuring performance of a set of time-series data, the system identifies the datasets that refer to the metric. Alternatively, the system may identify data sets of a type that the metric measures. In some embodiments, the system identifies the proprietary storage location based on location information stored in the mapping of proprietary to non-proprietary terms. Additionally, or alternatively, the system may access an application programming interface (API) configured to provide the system with proprietary content data.

The system generates an enriched generative AI prompt based on the request and the mapping of proprietary to non-proprietary terms (Operation 216). The enriched generative AI prompt may further include proprietary content, such as tables, time-series data, and other descriptive data associated with proprietary content. In an example where a proprietary term describes a type of visualization, the enriched generative AI prompt may include data describing the visualization and/or an example of the visualization.

According to one example, the system generates an enriched generative AI prompt including (a) a set of instructions to output visualization content referencing proprietary content, (b) mapping data describing a relationship of proprietary terms to non-proprietary terms, and (c) datasets of characteristics of proprietary data. For example, the enriched generative AI prompt may specify that “The term [X] means [Y],” where X is a proprietary term, and Y is a non-proprietary term. Additionally, or alternatively, the enriched generative AI prompt may specify that “The term [X] is a device with the following characteristics: A, B, C”, where A, B, and C describe non-proprietary characteristics of X.

Continuing to FIG. 2B, the generative AI model generates a visualization based on the request and the mapping of proprietary terms to non-proprietary terms (Operation 218). For example, the generative AI model trained on non-proprietary content uses the mapping data to identify a non-proprietary visualization associated with a proprietary term in the request. The generative AI model identifies the visualization based on patterns learned during training on the non-proprietary content. For example, the mapping data may identify a proprietary term as being an assignment or task type. The generative AI may identify a bipartite graph used to match employees to assignments. Additionally, or alternatively, the mapping data may identify a set of proprietary terms as being the names of a hierarchy of divisions within a company. The generative AI may identify a tree graph as corresponding to displaying hierarchies. Additionally, or alternatively, the mapping data may identify proprietary data as corresponding to a category of product. The generative AI may identify a bar graph as displaying magnitude values for different categories. As another example, the mapping data may identify proprietary data as corresponding to a performance metric. The generative AI may identify a line graph as displaying performance metric values over time.

In some embodiments, the mapping data include data describing a correlation between a proprietary term for a visualization and one or more non-proprietary visualizations. For example, the prompt “Create a burn chart for the February 2024 Corporate Close” references proprietary data associated with an event “corporate close” as well as a proprietary name for a visualization “burn chart.” The mapping data includes a description of the term “burn chart” as a two-line graph comparing the total number of outstanding tasks on a particular date versus the expected outstanding tasks.

In many instances, a generative AI model may identify multiple different visualizations that correspond to a particular set of proprietary data. The generative AI model determines a visualization to generate based on additional content in the enriched generative AI prompt. For example, one prompt may direct the generative AI model to generate a visualization of a performance metric over time. Another prompt may direct the generative AI model to generate a visualization comparing a performance metric for one period of time between two departments in an organization. The generative AI model identifies a first visualization corresponding to the first prompt and a second visualization corresponding to the second prompt. The system displays a visualization in a GUI based on the visualization content generated by the generative AI model.

The system determines if negative feedback is received in response to the visualization content generated by the generative AI model (Operation 220). For example, a user may interact with interface elements in the GUI displaying the visualization to provide feedback that affirms or disapproves of the visualization. In an example where the system determines a request does not include proprietary content and the generative AI model generates a visualization based on non-proprietary content without mapping proprietary to non-proprietary terms, the feedback may include indicating that the request included proprietary content. In an example where the system determines conditions are not met to map a proprietary term to non-proprietary content and the generative AI model generates a visualization based on non-proprietary content without mapping proprietary to non-proprietary terms, the feedback may include indicating that the system should have generated an enriched prompt that includes a mapping of proprietary to non-proprietary terms. Feedback may include detecting a user revision to the visualization output by the generative AI model. Additionally, or alternatively, the feedback may indicate that the mapping of proprietary to non-proprietary terms was incorrect or incomplete.

As an example, a user may determine that a visualization is based on an incorrect mapping of proprietary content to non-proprietary content. A mapping may map a non-proprietary product of one type to a proprietary product of a different type. Alternatively, a non-proprietary metric may measure a different value than the proprietary metric. As another example, a user may determine that the visualization output by the generative AI model is not a desired visualization.

If the system determines that negative feedback was not received, the process ends (Operation 226). A user may view, analyze, copy, cut, manipulate, and store displayed visualization content.

On the other hand, if the system determines that negative feedback was received, the system requests additional mapping data to map proprietary terms to non-proprietary terms (Operation 222). Additionally, the system may request additional proprietary content to generate a visualization. For example, if mapping data includes a set of non-proprietary characteristics, the system may request additional characteristics. An initial set of non-proprietary characteristics may include “4×4” “offroad” and “vehicle.” The generative AI may generate a visualization based on all-terrain vehicles (ATVs). The user may provide feedback that the proprietary term “Grizzly” should not be mapped to ATV's. Based on the system's request for additional mapping data, a user may provide additional mapping data, including the characteristic “truck” associated with the term “Grizzly.” The system may further include “ATV” in the mapping data as a negative example. The generative AI model may incorporate negative examples in a content-generation process by refraining from using ATV data to generate visualization content.

As another example, a system may incorrectly map a proprietary metric “Gold” to a non-proprietary metric “accounts with balances over $10,000.” Based on the system's request, the user may provide additional mapping data to replace the non-proprietary metric with “accounts with balances over $25,000.”

The system stores the additional mapping data (Operation 224). Storing the additional mapping data may include modifying a set of mapping tables. Additionally, storing the additional mapping data may include modifying a dictionary. For example, a system may add new non-proprietary terms and/or characteristics to a mapping with a proprietary term. The system may also remove non-proprietary terms and/or characteristics from the mapping.

Based on the updated mapping data, the system returns to Operation 212 to determine if criteria are met to apply a proprietary-to-non-proprietary mapping in an enriched generative AI prompt.

### 4. Training a Term Classification Machine Learning Model

A detailed example is described below for purposes of clarity. Components and/or operations described below should be understood as one specific example that may not be applicable to certain embodiments. Accordingly, components and/or operations described below should not be construed as limiting the scope of any of the claims.

A system obtains a pre-trained ML model (Operation 302). In one embodiment, the pre-trained machine learning model is a pre-trained semantic analysis model. Examples of semantic analysis models include Word2Vec, GloVe, and BERT. The semantic analysis model may be a transformer-type ML model such as an LLM. The semantic analysis model is trained on a dataset that includes a broad vocabulary to learn relationships among words and grammatical rules. The semantic analysis model is trained to receive a sequence of tokens that represent words and sub-words as input data and to generate an embedding representing the sequence as output data. The embedding is a multi-dimensional numerical vector.

The system creates a classification head by attaching an additional neural network layer to the output of the pre-trained ML model (Operation 304). Adding the classification head results in generating a different type of output data from the pre-trained ML model. While the pre-trained ML model is configured to receive sequences of tokens as input data and generate a semantic embedding as output data, the classification head is configured to receive the embeddings from the pre-trained ML model as input data and generate a classification of “proprietary” or “non-proprietary.”

The system freezes the parameters of the pre-trained ML model (Operation 306). The offsets and coefficients of the pre-trained ML model are set at their pre-trained values to prevent the parameters from changing in subsequent training of the fine-tuned ML model, including the fine-tuning head.

The system trains a term classification model that includes the pre-trained semantic analysis model and the classification head with term classification datasets to generate term classification predictions (Operation 308). During fine-tuning of the term classification model, the parameters of the pre-trained ML model remain frozen while the system modifies the parameters of the neurons that make up the classification head.

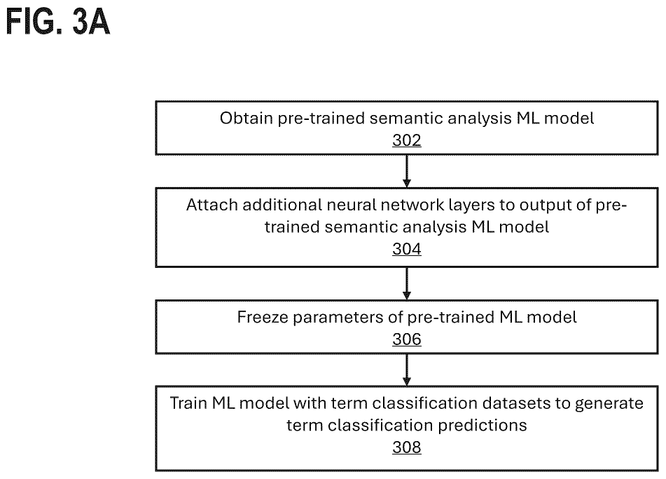

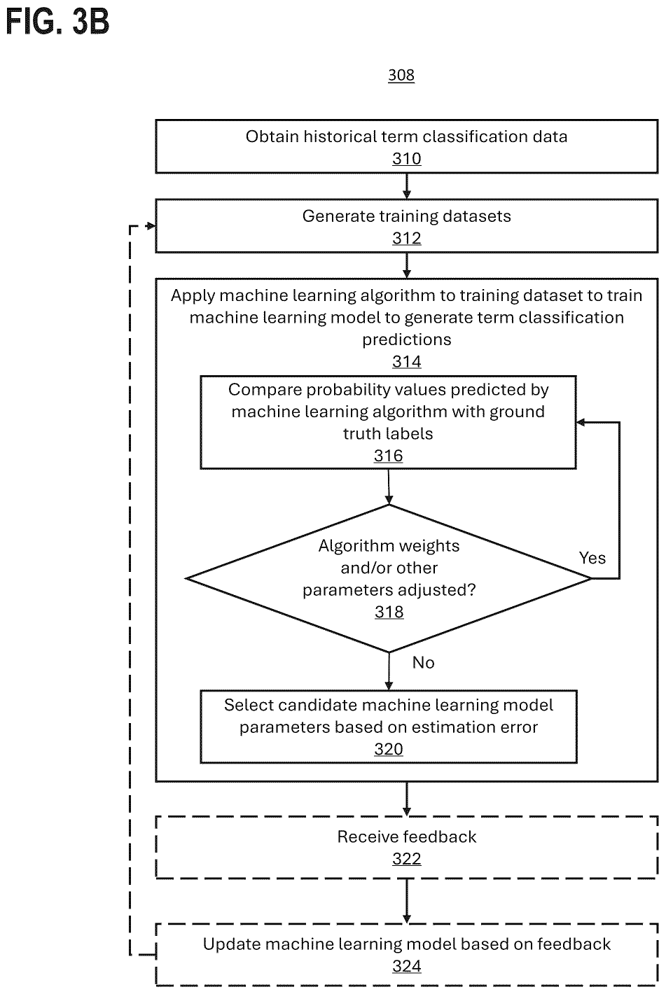

FIG. 3B describes the training of the term classification model to classify terms as proprietary terms or non-proprietary terms in further detail. In one or more embodiments, a system (e.g., one or more components of system 100 illustrated in FIG. 1A) obtains historical term classification data (Operation 310). Obtaining the historical term classification data may include obtaining historical and synthetic records specifying (a) a request to a generative AI model and (b) labels specifying whether terms in the request are proprietary or non-proprietary.

The system uses the historical and synthetic term classification data to generate a set of training data (Operation 312). The set of training data includes, for a particular term or phrase, at least one classification label. The classification label specifies if a term or a phrase is a proprietary term or a non-proprietary term.

According to one embodiment, the system obtains the historical term classification data and the training data set from a data repository storing labeled data sets. According to one embodiment, the system generates the labeled set of data by parsing documents and generating labels based on parsed values in the documents. According to an alternative embodiment, one or more users generate labels for a data set.

In some embodiments, generating the training data set includes generating a set of feature vectors for the labeled examples. A feature vector, for example, may be n-dimensional, where n represents the number of features in the vector. The number of features that are selected may vary depending on the implementation. The features may be curated in a supervised approach or automatically selected from extracted attributes during model training and/or tuning. Example features include embedding values generated by a semantic-type ML model and information about a user entering a request. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the ML model to generate term classification predictions (Operation 314). For example, the machine learning algorithm may analyze the training data set to train neurons of a neural network in the classification head of the ML model with particular weights and offsets to associate particular terms with particular classifications. The system trains the neurons of the neural network of the classification head without modifying neurons of the pre-trained ML model.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data.

In some embodiments, the system compares the probability values estimated through the one or more iterations of the ML model algorithm with ground truth labels to determine an estimation error (Operation 316). The system may perform this comparison for a test set of examples that may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error (Operation 318). Adjustments may be made until a candidate model that minimizes the estimation error or otherwise achieves a threshold level of estimation error is identified. The process may return to Operation 318 to adjust and continue training the ML model.

In some embodiments, the system selects ML model parameters based on the estimation error meeting a threshold accuracy level (Operation 320). For example, the system may select a set of parameter values for an ML model based on determining that the trained model has an accuracy level for predicting proprietary terms and phrases in requests to generative AI models of at least 98%.

In some embodiments, the system trains a neural network of the classification head using backpropagation without applying the backpropagation to the pre-trained ML model.

Backpropagation is a process of updating cell states in the neural network based on gradients determined as a function of the estimation error. With backpropagation, nodes are assigned a fraction of the estimated error based on the contribution to the output and adjusted based on the fraction.

In embodiments in which the machine learning algorithm is a supervised machine learning algorithm, the system may optionally receive feedback on the various aspects of the analysis described above (Operation 322). For example, the feedback may affirm or revise labels generated by the ML model. The ML model may predict that a term in a request to a generative AI model is a non-proprietary term. The system may receive feedback indicating that the term is a proprietary term. Based on the feedback, the ML training set may be updated (Operation 324), thereby improving its analytical accuracy. Once updated, the system may further train the ML model by optionally applying the model to additional training data sets.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

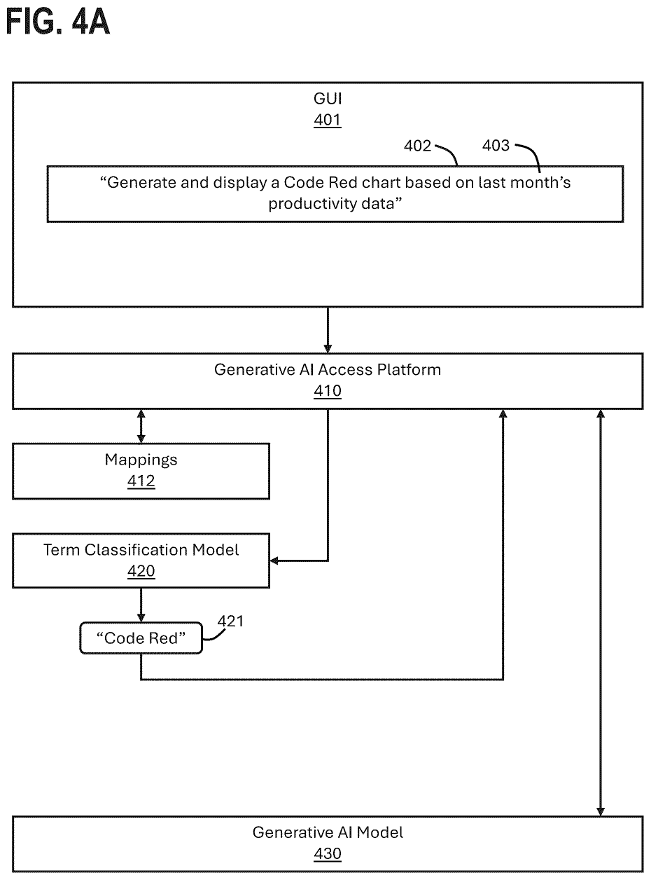

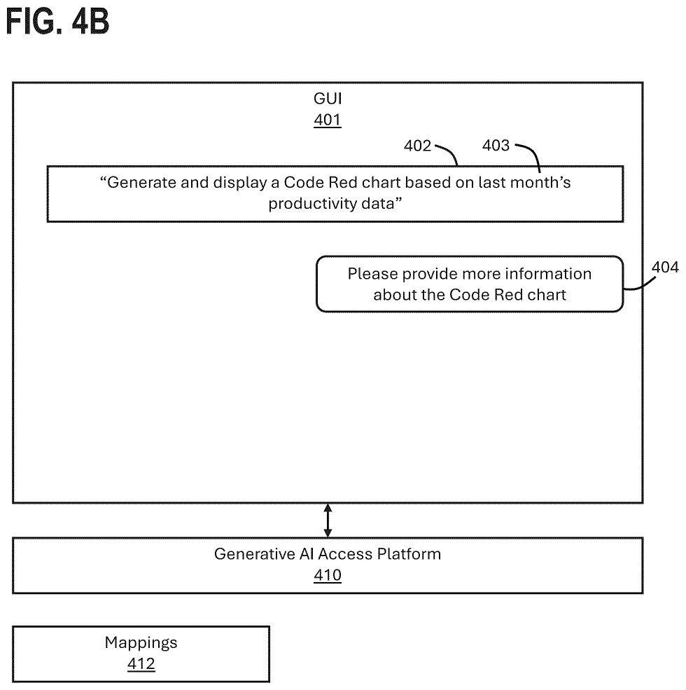

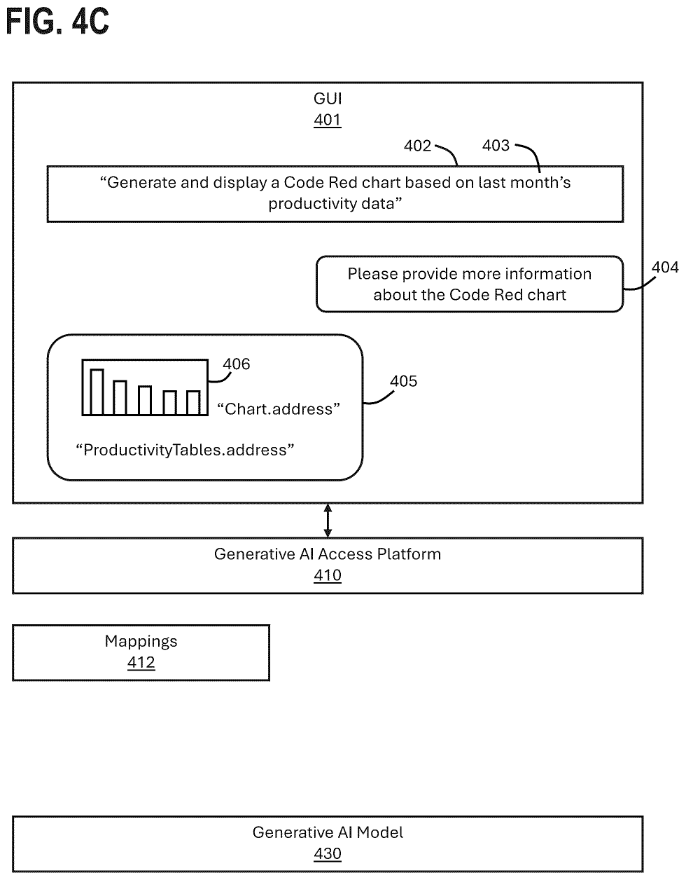

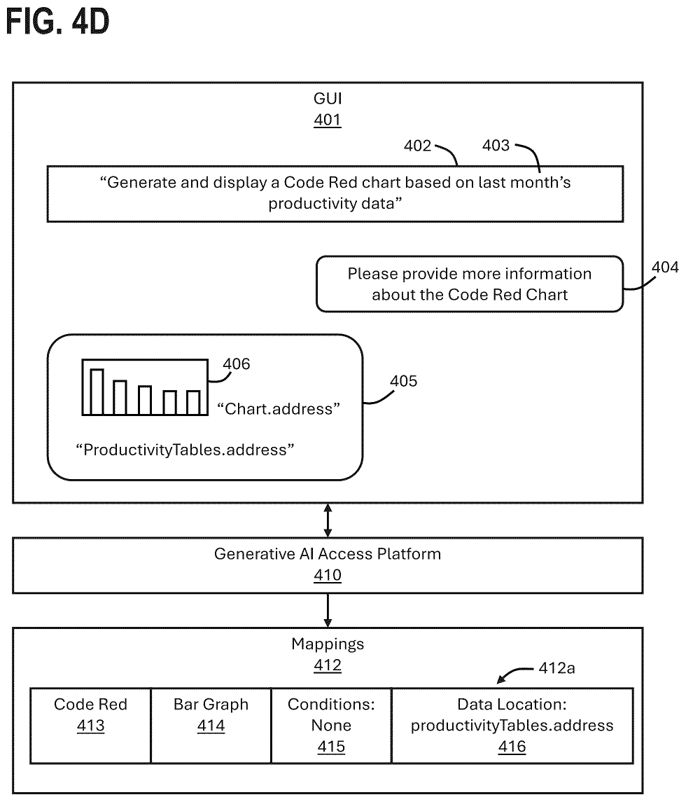

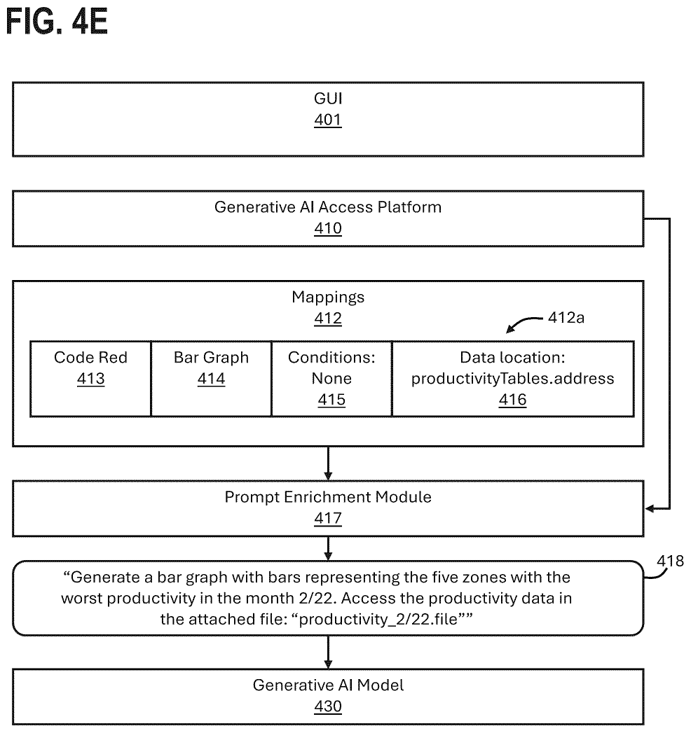

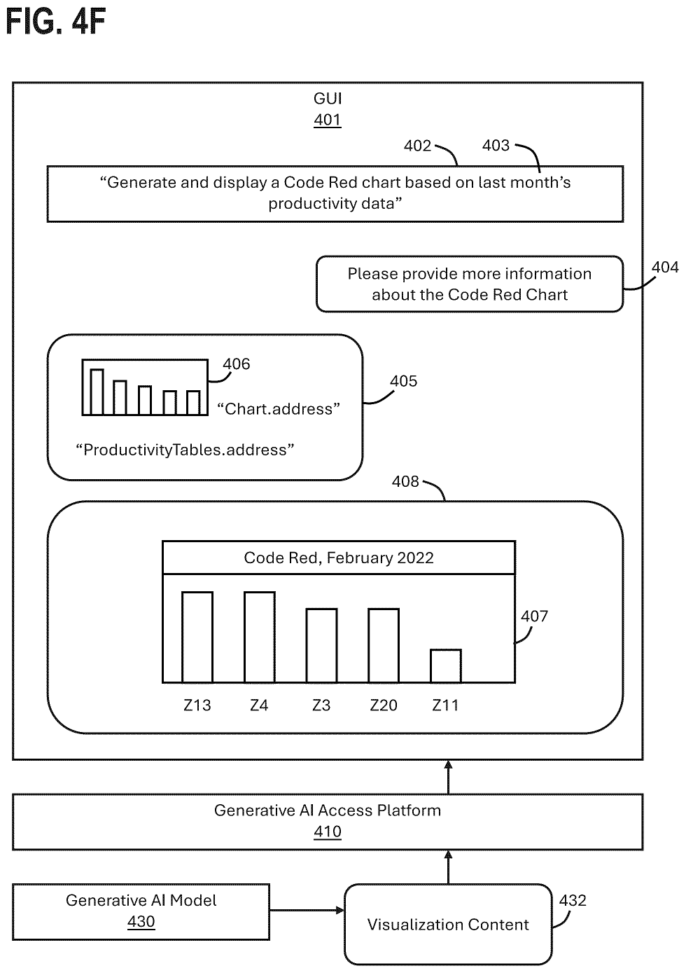

FIGS. 4A-4F illustrate operations for generating enriched prompts to direct a generative AI to generate visualizations based on proprietary content. Referring to FIG. 4A, a GUI 401 includes a text entry field 402. A user enters a request 403 into the text entry field 402. The request 403 is a natural language request directed to a generative AI model to direct the generative AI model to generate a visualization. The generative AI access platform 410 parses the request 403 and compares the parsed words and phrases against the mapping 412. The mapping includes a list of proprietary terms and corresponding (a) non-proprietary terms and/or (b) content location for content that corresponds to the proprietary terms. In the example illustrated in FIG. 4A, the generative AI access platform 410 determines that the terms in the request 403 are not included among the proprietary terms in the mapping 412. The generative AI access platform 410 then applies a term classification model 420 to the request 403. The term classification model 420 includes a semantic-type ML model to generate embeddings of tokens in the request 403 based on semantic content and relationships with other tokens. The term classification model 420 further includes a classification head appended to the semantic model to classify a token as proprietary or non-proprietary.

The term classification model 420 classifies the term “Code Red” 421 in the request 403 as being a proprietary term. Since a generative AI model 430 is not trained on the meaning of “Code Red” as it is used in the context of the request 403, the generative AI model 430 could not fulfill the intent of the request to generate a particular type of visualization without further information.

Referring to FIG. 4B, the generative AI access platform 410 generates a message 404 in the GUI 401 to request further information about the term “Code Red” that has been identified as a proprietary term. The generative AI access platform 410 may determine from the semantic machine learning model included in the term classification model 420 that the term “Code Red” in the request 403 refers to a type of chart. The generative AI access platform 410 composes a message based on the semantic data obtained from the semantic model and the classification obtained from the term classification model 420, which is implemented as a classification head appended to the semantic model.

Referring to FIG. 4C, a user generates a message 405 including an example of a Code Red chart 406. The user may attach a file “Chart. address” to the message. The user may further attach a file “ProductivityTables. address” to the message. The file “ProductivityTables. address” includes productivity data for an entity. According to another example, a user may attach the chart 406 to the message 405 without attaching the productivity tables. The generative AI access platform 410 may determine that the productivity data is needed to generate the example chart. Accordingly, the generative AI access platform 410 may generate a follow-up message to request the productivity tables.

Referring to FIG. 4D, the generative AI access platform 410 generates a new mapping 412a in the mappings 412 for the proprietary term “Code Red.” The mapping 412a includes the following: (a) the proprietary term “Code Red” 413, (b) a non-proprietary term describing the type of the proprietary term, “Bar Graph” 414, (c) a field for conditions associated with applying the mapping “None” 415, and a data location of proprietary data required to generate a visualization based on the proprietary term “Data location: productivityTables. address” 416.

Referring to FIG. 4E, a prompt enrichment module 417 obtains the mapping 412a for the term “Code Red” 413 from the set of mappings 412. The prompt enrichment module 417 further obtains the request 403 from the generative AI access platform 410. The prompt enrichment module 417 generates an enriched prompt 418 that incorporate: (a) the terms in the request 403 and (b) the additional content from the mapping 412a that maps the proprietary term “Code Red” 413 to non-proprietary terms 414 and to additional proprietary content 416 for generating a visualization. The prompt enrichment module 417 provides the enriched prompt 418 to the generative AI model 430.

Referring to FIG. 4F, the generative AI model 430 generates visualization content 432 based on the enriched prompt 418. The visualization content may include a data file, such as a PDF file, text content, and an image file, such as a JPG file, a PNG file, or a GIF file.

Additionally, or alternatively, the visualization content 432 may be presented in an HTML file. The generative AI access platform 410 receives the visualization content 432 and displays the visualization content 432 as a visualization 407 in a message 408 in the GUI 401. The visualization 407 incorporates proprietary content by presenting a visualization of the “Code Red” type as described in the mapping 412a. The visualization 407 further incorporates proprietary content by accessing productivity data from the file location productivityTables. address specified in the mapping 412a.

An example embodiment is described above in FIGS. 4A-4F, where proprietary content includes a proprietary name of a visualization. Additional embodiments include proprietary names of metrics to be represented in a visualization such as a request including “Generate and display a line graph of MasterWidget production over the past month.” The term “MasterWidget” may be a proprietary term used within a company that is not used outside the company. Accordingly, a generative AI model may not be trained to be capable of generating a visualization based on the term “MasterWidget.” In this example embodiment, a mapping enrichment module includes, in a generative AI prompt, a mapping of the term “MasterWidget” to company-maintained production data for the product “MasterWidget.”

Generative AI models are trained on billions of data records, including visualization records, such as charts, graphs, and images. Generative models learn the underlying distribution of the training data, enabling them to produce new instances of data that share properties with the original dataset. One or more embodiments improve the functionality of systems that use generative AI models to generate visualizations by providing the generative AI model with the functionality to generative visualizations based on proprietary data that the generative AI model may not have been trained on. For example, the proprietary data may include a name used for a visualization within a company that was not included in the same context in the training data used to train the generative AI model. As another example, the proprietary data may include a proprietary name of a metric that is used within a company, where the generative AI training data set either did not include the proprietary name or its sample size was insufficient to train the generative AI model to generate a visualization based on the proprietary name.

Embodiments improve the functionality of systems that rely on generative AI models to generate visualization content by (a) intercepting requests to generative AI models, (b) identifying proprietary content in the requests that a generative AI model may not be trained to be capable of using proprietary content to generate outputs, and (c) generating enriched prompts to the generative AI model that include mappings of proprietary content to non-proprietary content. From a user's perspective interfacing with a GUI, the user enters requests and receives output visualizations. Embodiments implement a back-end analysis and enrichment layer to facilitate the seamless user experience. The back-end analysis and enrichment layer identify the proprietary content and generate enriched prompts, using the user's request and mappings of proprietary data to non-proprietary data and/or proprietary context data to provide to the generative AI model.

The enriched prompts provide additional functionality to the generative AI model to be able to generate visualizations based on proprietary content that the generative AI model may not otherwise have been trained to generate. Furthermore, the enriched prompts provide the additional functionality for the generative AI model without requiring a computing-resource-intensive process of retraining a generative AI model. Additionally, a set of proprietary data, such as statistics for sales of a small company, may not be available in a sufficient sample size to train a generative AI model. Accordingly, the enriched prompts provide functionality to the generative AI model to generate visualizations for proprietary data that corresponds to a sample size insufficient to train the generative AI model.

6. Generating Scheduling Visualizations with Generative AI using Enriched Prompts

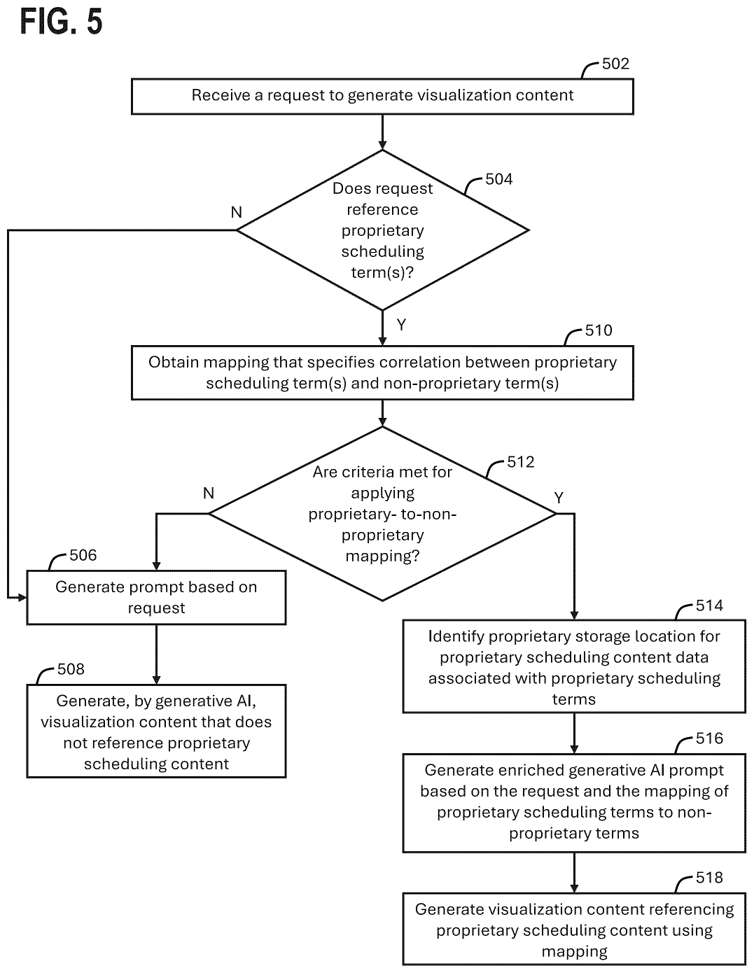

FIG. 5 illustrates an example set of operations for generating visualizations with generative AI using enriched prompts in accordance with one or more embodiments. One or more operations illustrated in FIG. 5 may be modified, rearranged, or omitted. Accordingly, the sequence of operations illustrated in FIG. 5 should not be construed as limiting the scope of one or more embodiments.

A system receives a request to generate scheduling visualization content (Operation 502). The visualization may be a chart, a graph, or other image. In some embodiments, the instructions are in the form of a natural language request directed to a generative AI model. For example, a user may enter words and symbols into a field that is used to generate prompts for a generative AI model. The system may receive and process the request before determining whether or not to modify the content in the request prior to passing the instruction to the generative AI model. In one embodiment, a scheduling application or GUI includes a text entry field or an interface element that initiates content generation by the generative AI model. The system may determine a context for a request to generate content by the generative AI model based on determine the request is initiated from the scheduling application or GUI. In other words, the system may determine that a request to generate content refers to scheduling data, even if the term scheduling is not included in the request, based on the request being initiated from the scheduling application or GUI.

The system determines if the request includes proprietary scheduling content (Operation 504). Proprietary scheduling content includes scheduling terms used within an organization that are not commonly used outside the organization. For example, an organization may use proprietary terms for products under development, for applications used by the organization, for positions within the organization, for visualizations of content, and/or for metrics that measure performance of employees, systems, manufacturing processes, workflows, and sales in the organization.

For example, an organization may use the terms “pebble,” “boulder,” and “mountain” to describe categories of scheduling issues. Within the organization, a “pebble” may refer to a small and easily resolved issue, while a “mountain” refers to a challenging issue requiring significant resources to address. For example, within an organization, a “pebble” type scheduling issue may refer to an issue that can be resolved by changing an employee's assignment. A “mountain” type scheduling issue may refer to an issue that requires opening up a new production line or hiring and training a new team to maintain a forecasted production schedule. As another example, a company may have a product called the “Grizzly” under production. A user requesting a visualization may enter the terms “generate a chart showing the current ratio of pebbles, boulders, and mountains for the program South America 5G Rollout.” According to another example, an entity may use a proprietary name, “Excellence-o-meter,” to refer to a visualization or graphic. Outside the company, the chart may have a different name such as “gauge graph.”

The system may include a generative AI screening platform that screens user-generated instructions to the generative AI model to identify proprietary scheduling terms that have one meaning within an organization and a different meaning, or no meaning, outside the organization. The generative AI screening platform may be interposed between a user interface component in a system and the generative AI model. The generative AI access platform 110 represented in FIG. 1A is an example of a generative AI screening platform. For example, a user may enter content into a field with the intent to transmit the content to the generative AI model to generate a visualization. The generative AI screening platform intercepts the content, or request, prior to transmitting the request to the generative AI model. The generative AI screening platform may store reference tables to proprietary scheduling terms for an organization. The system may retrieve and parse proprietary data sets to identify the proprietary scheduling terms.

In an embodiment, the system determines if a request includes proprietary scheduling content by comparing terms, tokens, and phrases in the request with a mapping and/or a dictionary of proprietary terms, tokens, and phrases. A system may store a mapping of identified proprietary scheduling terms and phrases. The mapping may include non-proprietary terms and/or phrases that correspond to the proprietary scheduling terms and phrases. The system may determine that the request includes a proprietary scheduling term or phrase when the term or phrase is present among the proprietary terms and phrases in the mapping.

Similarly, a system may maintain a dictionary of proprietary scheduling terms and phrases as well as corresponding non-proprietary definitions of the proprietary scheduling terms and phrases. The system may determine that the request includes a proprietary scheduling term or phrase when the term or phrase is present among the proprietary scheduling terms and phrases in the dictionary.

One or more embodiments employ a trained machine learning model to analyze received instructions to determine if terms are proprietary or non-proprietary. For example, a term may have one meaning within an organization and another meaning outside the organization. The system may provide a set of instructions to a semantic analysis type machine learning model to determine if the terms included in the instructions refer to proprietary content or non-proprietary content. Examples of semantic analysis models that may be used include Word2Vec, Global Vectors for Word Representation (GloVe), and Bidirectional Encoder Representations from Transformers (BERT).

One or more embodiments employ a hybrid approach to determining whether a request includes proprietary scheduling terms and/or phrases. The hybrid approach includes (a) comparing terms and phrases in the request to a mapping and (b) applying a trained machine learning model to the request to identify proprietary scheduling terms and phrases that are not included in the mapping. The system may apply the hybrid approach sequentially. The system may first compare terms and phrases in the request to the mapping to determine if the terms and phrases are included as proprietary scheduling terms or phrases in the mapping. If the system determines the terms or phrases are included in the mapping, the system may refrain from applying the trained machine learning model. However, if the system fails to identify terms or phrases from the request in the mapping, the system may apply the trained machine learning model to determine whether proprietary scheduling terms or phrases are included in the request that are not yet included in the mapping.

If the system determines the request does not include proprietary scheduling content, the system generates a prompt based on the request (Operation 506). The system may pass the request on to the generative AI without modifying the request. Alternatively, the system may modify the request to include structural elements for the generative AI prompt. For example, the system may add context data specifying a tone to apply to a generative AI output, colors to include in the generative AI output, and a format or file type of the visualization.

Based on the prompt, the generative AI generates visualization content (Operation 508). The visualization is based on the patterns learned by the generative AI during training on the non-proprietary training data and any modifications to the request included in the prompt. Since the training data does not include proprietary scheduling content or does not include sufficient proprietary scheduling content to train the generative AI to generate output data referencing proprietary content, the visualization does not include proprietary scheduling content. In some examples where a term may have both a proprietary meaning and a non-proprietary meaning, the generative AI model generates a visualization based on the non-proprietary meaning.

If the system determines that the request includes proprietary scheduling content, the system obtains mapping data that specifies relationships between proprietary scheduling content and non-proprietary content (Operation 510). Mapping data includes a mapping of proprietary scheduling terms to non-proprietary terms. The mapping data may further include a description or definition of a proprietary scheduling term. The mapping data may further include a location where a system may go to retrieve data for generating a visualization based on the proprietary scheduling content.

For example, a request entered into a field in a GUI may include “generate a story based on [content X].” An organization may use the term “story” in a proprietary context in a way that is distinct from the non-proprietary use of the term. The organization may refer to a set of related scheduling tables used in a scheduling platform as a “Story.” The system obtains mapping data that includes a mapping of the proprietary term “Story” to the non-proprietary terms “set of scheduling tables”

The mapping data may further include conditions. The conditions may tell the generative AI model whether the word(s) included in the request should be interpreted as proprietary content or non-proprietary content. For example, the mapping data may include a condition: “When [content X] specifies [data type Y], apply mapping of proprietary term to non-proprietary term. When [content X] specifies [data type Z], refrain from applying the mapping and use non-proprietary term.” When the system receives feedback (described below) associated with visualizations, the system may store the feedback as conditions to be applied to future requests that include a proprietary term.

Mapping data may also include attributes and characteristics. For example, a company may develop an offroad vehicle named “Grizzly.” Mapping data may include non-proprietary data describing the Grizzly, such as “4×4”, “offroad,” “vehicle”, and “4-seater.”

In one embodiment, the system stores a dictionary of proprietary scheduling terms, mapping data associated with the proprietary scheduling terms, and conditions for determining when to apply the mapping of proprietary scheduling terms to non-proprietary scheduling terms. Additionally, or alternatively, the system may parse proprietary content to identify mapping data. For example, a machine-learning model may identify a proprietary scheduling term in a request directed to a generative AI model. The system may refer to a dictionary to determine if the proprietary scheduling term is in the dictionary. If the term is in the dictionary, the system obtains a set of mapping data associated with the proprietary scheduling term from the dictionary. However, if the term is not in the dictionary, the system accesses proprietary data sets to extract mapping data. The system may present a request to a user in a GUI for a data storage location from where the system may extract the mapping data. The system may use a semantic analysis machine learning model to identify terms in the proprietary data that describe and/or define the proprietary scheduling term. In one embodiment, the system adds the new proprietary scheduling term and corresponding mapping data to the dictionary.

In one embodiment, a generative AI screening platform interposed between a user interface and a generative AI model accesses a set of proprietary data maintained by an entity to determine correlations between proprietary and non-proprietary concepts and terms. Proprietary data may include, for example, a listing of products offered by an entity or names for tasks in a project workflow. Tasks may include task descriptions. Based on the task descriptions, the generative AI screening platform may determine a non-proprietary task type. The generative AI screening platform may then map the non-proprietary task type to the proprietary scheduling term included in the request to the generative AI model.

According to another example, the system may compare an example corresponding to a proprietary scheduling term with non-proprietary examples to identify a relationship of a proprietary scheduling term to a non-proprietary scheduling term. For example, the system may identify the term “complete-o-meter” as a proprietary scheduling term in a request to a generative AI model. The system may identify, in an entity's stored proprietary data, an image of a gauge graph corresponding to the description “complete-o-meter.” The system may determine the proprietary scheduling term “complete-o-meter” corresponds to the non-proprietary scheduling term gauge graph.

The system determines if criteria are met to apply a mapping of a proprietary scheduling term to a non-proprietary term (Operation 512). Determining if the criteria are met may include analyzing the textual context of a term. For example, a request may include the words “generate a line graph showing the performance of silver and gold projects.” The system may identify Silver and Gold proprietary scheduling terms within an organization that describe types of programs and projects being carried out by the organization. The system may determine that the mapping of the terms “Silver” and “Gold” to proprietary content is conditional on the terms being used to describe program development and completion. The system determines from the context of the request that the request is directed to programs being carried out by a company. Accordingly, the system applies the mapping of the proprietary scheduling terms to a non-proprietary scheduling term “program.” The mapping may further specify where the system should go to obtain information about the performance of the programs.

If the criteria are not met to apply a non-proprietary to proprietary mapping, the system proceeds to Operation 506 to generate a prompt based on the request, using the non-proprietary meaning of the terms. Referring to the example above where “Silver” and “Gold” refer to types of programs carried out by an organization, a request may include the terms “generate a bar graph of the price of gold for the past year.” The system determines that the term “gold” is not associated with programs, but rather with the metal. Accordingly, the system generates the prompt to the generative AI model without mapping the term “gold” to a non-proprietary scheduling term “program”, and without enriching the prompt with proprietary contextual data in the prompt.

In one embodiment, determining if criteria are met to apply a mapping of proprietary scheduling terms to non-proprietary may be based on specified criteria such as the criteria 124c-124n stored in the mapping 121 represented in FIG. 1D. These criteria may include whether specified terms are used in the same request as the proprietary scheduling term or the identity of a user initiating a request. For example, if the system determines a user generating a request is not included in a set of criteria for applying a mapping, the system may execute the request without generating an enriched prompt including the mapping of proprietary scheduling terms to non-proprietary terms. If the system determines a user generating a request is included in a set of criteria for applying the mapping, the system may execute the request by generating an enriched prompt including the mapping of proprietary scheduling terms to non-proprietary scheduling terms.

In another embodiment, determining if criteria are met to apply a mapping may be based on the output from a semantic machine learning model such as the semantic analysis model 115 represented in FIG. 1A. The semantic analysis model 115 may generate an embedding for tokens in a request. The embedding may include information representing whether or not to apply a mapping of proprietary scheduling terms to non-proprietary scheduling terms. Additionally, or alternatively, determining if criteria are met to apply a mapping may be based on the output from a classification-type machine learning model, such as the term classification model 116, represented in FIG. 1A. The system may be configured to apply a proprietary-to-non-proprietary mapping when the term classification model 116 classifies a term as “proprietary.”

If the system determines that criteria are met to apply a mapping of proprietary scheduling terms to non-proprietary scheduling terms, the system further identifies a proprietary storage location for proprietary content data (Operation 514). For example, if the proprietary scheduling term corresponds to a program for rolling out a product, the system identifies data sets associated with the product. If the proprietary scheduling term is a term used in business workflows, the system identifies the business workflows that reference the term. If the proprietary scheduling term is a metric measuring performance of a set of time-series data, the system identifies the datasets that refer to the metric. Alternatively, the system may identify data sets of a type that the metric measures. In some embodiments, the system identifies the proprietary storage location based on location information stored in the mapping of proprietary to non-proprietary terms. Additionally, or alternatively, the system may access an application programming interface (API) configured to provide the system with proprietary content data.

The system generates an enriched generative AI prompt based on the request and the mapping of proprietary scheduling terms to non-proprietary terms (Operation 516). The enriched generative AI prompt may further include proprietary content, such as tables, time-series data, and other descriptive data associated with proprietary scheduling content. In an example where a proprietary scheduling term describes a type of visualization, the enriched generative AI prompt may include data describing the visualization and/or an example of the visualization.

According to one example, the system generates an enriched generative AI prompt including (a) a set of instructions to output visualization content referencing proprietary scheduling content, (b) mapping data describing a relationship of proprietary scheduling terms to non-proprietary terms, and (c) datasets of characteristics of proprietary data. For example, the enriched generative AI prompt may specify that “The term [X] means [Y],” where X is a proprietary scheduling term, and Y is a non-proprietary term. Additionally, or alternatively, the enriched generative AI prompt may specify that “The term [X] is a device with the following characteristics: A, B, C”, where A, B, and C describe non-proprietary characteristics of X.

The generative AI model generates a scheduling visualization based on the request and the mapping of proprietary scheduling terms to non-proprietary terms (Operation 518). For example, the generative AI model trained on non-proprietary content uses the mapping data to identify a non-proprietary visualization associated with a proprietary scheduling term in the request. The generative AI model identifies the visualization based on patterns learned during training on the non-proprietary content. For example, the mapping data may identify a proprietary scheduling term as being an assignment or task type. The generative AI may identify a bipartite graph used to match employees to assignments. Additionally, or alternatively, the mapping data may identify a set of proprietary scheduling terms as being the names of a hierarchy of divisions within a company. The generative AI may identify a tree graph as corresponding to displaying hierarchies. Additionally, or alternatively, the mapping data may identify proprietary data as corresponding to a category of product. The generative AI may identify a bar graph as displaying magnitude values for different categories. As another example, the mapping data may identify proprietary data as corresponding to a performance metric. The generative AI may identify a line graph as displaying performance metric values over time.

In some embodiments, the mapping data include data describing a correlation between a proprietary scheduling term for a visualization and one or more non-proprietary visualizations. For example, the prompt “Create a burn chart for the February 2024 Corporate Close” references proprietary data associated with an event “corporate close” as well as a proprietary name for a visualization “burn chart.” The mapping data includes a description of the term “burn chart” as a two-line graph comparing the total number of outstanding tasks on a particular date versus the expected outstanding tasks.

In many instances, a generative AI model may identify multiple different visualizations that correspond to a particular set of proprietary data. The generative AI model determines a visualization to generate based on additional content in the enriched generative AI prompt. For example, one prompt may direct the generative AI model to generate a visualization of a performance metric over time. Another prompt may direct the generative AI model to generate a visualization comparing a performance metric for one period of time between two departments in an organization. The generative AI model identifies a first visualization corresponding to the first prompt and a second visualization corresponding to the second prompt. The system displays a visualization in a GUI based on the visualization content generated by the generative AI model.

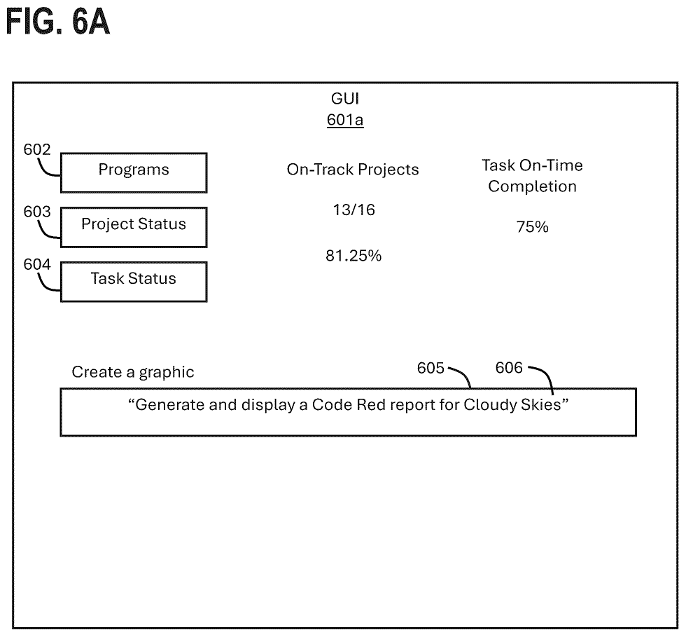

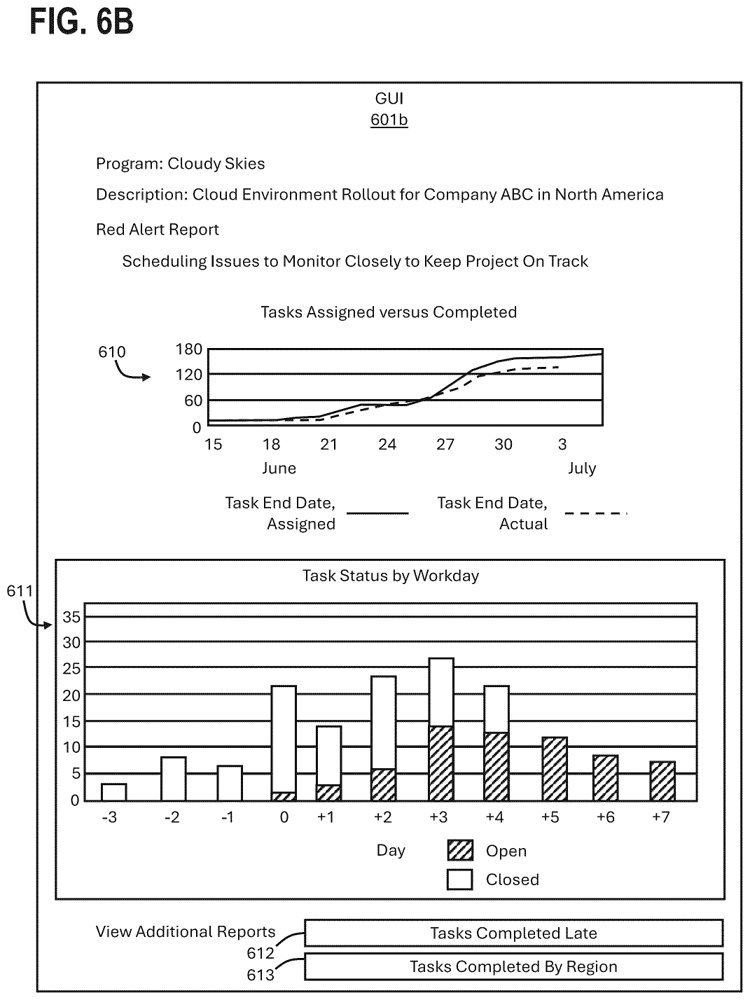

FIGS. 6A and 6B illustrates an example set of proprietary scheduling graphs generated by a generative AI model using mappings of proprietary scheduling terms to non-proprietary terms. In the example embodiment illustrated in FIG. 6A, a GUI 601a displays scheduling data, including buttons to display information about programs 602, project status 603, and task status 604. The GUI 601a displays examples of key metrics data including on-track projects and task on-time completion. The GUI 601a includes a text entry field 605. Entering text in the text entry field generates a request to a generative AI model to generate content. Since the GUI 601a presents scheduling data, a system generates a prompt to the generative AI model that provides scheduling context data to enable the generative AI model to generate the content.

A user enters a request 606 to “generate and display a code red report for Cloudy Skies.” The request includes proprietary scheduling terms “Code Red” and “Cloudy Skies.” The system identifies the proprietary scheduling terms by comparing terms in the request 606 to a mapping of proprietary terms. Based on determining the terms are proprietary scheduling terms, the system generates a prompt for the generative AI model that includes a mapping of the proprietary terms to non-proprietary content.

For example, the system determines a “Code Red” report refers to a set of charts that depict metrics-of-interest for a program or project. The system may determine the metrics-of-interest based on comparing performance metrics for tasks and projects in a program to thresholds. In addition, the system may determine metrics that have a strong influence on program performance. The system further determines that the term “Cloudy Skies” refers to a particular program at Company Y, or the company that manages the scheduling application associated with the GUI 601a. The system obtains task data associated with the program “Cloudy Skies”from a location in memory pointed to by a mapping.

Based on the prompt that includes the mapping of proprietary terms to non-proprietary terms and content, the system presents GUI 601b including visualizations 610 and 611. Visualization 610 is a line graph depicting tasks assigned versus tasks completed. The generative AI model obtains (a) the type of graph to be generated, and (b) the information to be presented in the line graph based on the mapping of proprietary to non-proprietary content included in the generative AI prompt. In particular, the system maps the term “Red Alert” report to a set of visualizations including the tasks assigned versus completed line graph 610, the task status by workday bar graph 611, a tasks completed late visualization, and a tasks completed by region bar graph. The system further provides a location in memory of task data for generating the visualizations.

Visualization 611 is a bar graph chart depicting task status by workday. The generative AI model obtains (a) the type of chart to be generated, and (b) the information to be presented in the bar graph based on the mapping of proprietary to non-proprietary content included in the generative AI prompt. The GUI 600b includes buttons 612 and 613 to direct a user to additional AI-generated visualizations including a tasks completed late visualization and a tasks completed by region bar graph.

7. Generating Reconciliation Visualizations With Generative AI using Enriched Prompts

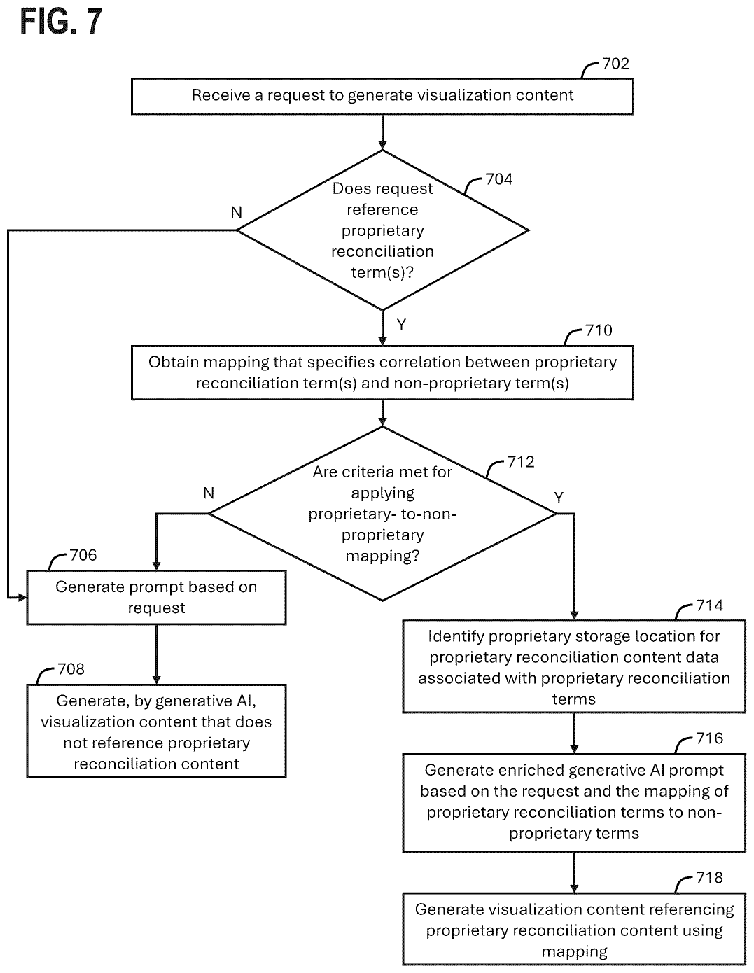

FIG. 7 illustrates an example set of operations for generating reconciliation visualizations with generative AI using enriched prompts in accordance with one or more embodiments. One or more operations illustrated in FIG. 7 may be modified, rearranged, or omitted. Accordingly, the sequence of operations illustrated in FIG. 7 should not be construed as limiting the scope of one or more embodiments.

A system receives a request to generate reconciliation visualization content (Operation 702). The visualization may be a chart, a graph, or other image. In some embodiments, the instructions are in the form of a natural language request directed to a generative AI model. For example, a user may enter words and symbols into a field that is used to generate prompts for a generative AI model. The system may receive and process the request before determining whether or not to modify the content in the request prior to passing the instruction to the generative AI model. In one embodiment, a reconciliation application or GUI includes a text entry field or an interface element that initiates content generation by the generative AI model. The system may determine a context for a request to generate content by the generative AI model based on determine the request is initiated from the reconciliation application or GUI. In other words, the system may determine that a request to generate content refers to reconciliation data, even if the term reconciliation is not included in the request, based on the request being initiated from the reconciliation application or GUI.

The system determines if the request includes proprietary reconciliation content (Operation 704). Proprietary reconciliation content includes reconciliation terms used within an organization that are not commonly used outside the organization. For example, an organization may use proprietary terms for account types, invoice types, payment types, and reconciliation types, for visualizations of content, and/or for metrics that measure reconciliations, such as numbers and types of reconciliations and the accuracy of reconciliations.

For example, an organization may use the terms “pebble,” “boulder,” and “mountain” to describe categories of reconciliation issues. Within the organization, a “pebble” may refer to a small and easily resolved issue, while a “mountain” refers to a challenging issue requiring significant resources to address. For example, within an organization, a “pebble” type reconciliation issue may refer to an issue that can be resolved by adjusting a single value in a single record. A “mountain” type reconciliation issue may refer to an issue that requires contacting third-parties to rectify errors, release funds, or modify financial data in accounts maintained by the third party. As an example, a user requesting a visualization may enter the terms “generate a chart showing the current ratio of pebbles, boulders, and mountains for the current year.” According to another example, an entity may use a proprietary name, “Excellence-o-meter,” to refer to a visualization or graphic. Outside the company, the chart may have a different name such as “gauge graph.”

The system may include a generative AI screening platform that screens user-generated instructions to the generative AI model to identify proprietary reconciliation terms that have one meaning within an organization and a different meaning, or no meaning, outside the organization. The generative AI screening platform may be interposed between a user interface component in a system and the generative AI model. The generative AI access platform 110 represented in FIG. 1A is an example of a generative AI screening platform. For example, a user may enter content into a field with the intent to transmit the content to the generative AI model to generate a visualization. The generative AI screening platform intercepts the content, or request, prior to transmitting the request to the generative AI model. The generative AI screening platform may store reference tables to proprietary reconciliation terms for an organization. The system may retrieve and parse proprietary data sets to identify the proprietary reconciliation terms.

In an embodiment, the system determines if a request includes proprietary reconciliation content by comparing terms, tokens, and phrases in the request with a mapping and/or a dictionary of proprietary terms, tokens, and phrases. A system may store a mapping of identified proprietary reconciliation terms and phrases. The mapping may include non-proprietary terms and/or phrases that correspond to the proprietary reconciliation terms and phrases. The system may determine that the request includes a proprietary reconciliation term or phrase when the term or phrase is present among the proprietary terms and phrases in the mapping.

Similarly, a system may maintain a dictionary of proprietary reconciliation terms and phrases as well as corresponding non-proprietary definitions of the proprietary reconciliation terms and phrases. The system may determine that the request includes a proprietary reconciliation term or phrase when the term or phrase is present among the proprietary reconciliation terms and phrases in the dictionary.

One or more embodiments employ a trained machine learning model to analyze received instructions to determine if terms are proprietary or non-proprietary. For example, a term may have one meaning within an organization and another meaning outside the organization. The system may provide a set of instructions to a semantic analysis type machine learning model to determine if the terms included in the instructions refer to proprietary content or non-proprietary content. Examples of semantic analysis models that may be used include Word2Vec, GloVe, and BERT.

One or more embodiments employ a hybrid approach to determining whether a request includes proprietary reconciliation terms and/or phrases. The hybrid approach includes (a) comparing terms and phrases in the request to a mapping and (b) applying a trained machine learning model to the request to identify proprietary reconciliation terms and phrases that are not included in the mapping. The system may apply the hybrid approach sequentially. The system may first compare terms and phrases in the request to the mapping to determine if the terms and phrases are included as proprietary reconciliation terms or phrases in the mapping. If the system determines the terms or phrases are included in the mapping, the system may refrain from applying the trained machine learning model. However, if the system fails to identify terms or phrases from the request in the mapping, the system may apply the trained machine learning model to determine whether proprietary reconciliation terms or phrases are included in the request that are not yet included in the mapping.

If the system determines the request does not include proprietary reconciliation content, the system generates a prompt based on the request (Operation 706). The system may pass the request on to the generative AI without modifying the request. Alternatively, the system may modify the request to include structural elements for the generative AI prompt. For example, the system may add context data specifying a tone to apply to a generative AI output, colors to include in the generative AI output, and a format or file type of the visualization.

Based on the prompt, the generative AI generates visualization content (Operation 708). The visualization is based on the patterns learned by the generative AI during training on the non-proprietary training data and any modifications to the request included in the prompt.

Since the training data does not include proprietary reconciliation content or does not include sufficient proprietary reconciliation content to train the generative AI to generate output data referencing proprietary content, the visualization does not include proprietary reconciliation content. In some examples where a term may have both a proprietary meaning and a non-proprietary meaning, the generative AI model generates a visualization based on the non-proprietary meaning.

If the system determines that the request includes proprietary reconciliation content, the system obtains mapping data that specifies relationships between proprietary reconciliation content and non-proprietary content (Operation 710). Mapping data includes a mapping of proprietary reconciliation terms to non-proprietary terms. The mapping data may further include a description or definition of a proprietary reconciliation term. The mapping data may further include a location where a system may go to retrieve data for generating a visualization based on the proprietary reconciliation content.

For example, a request entered into a field in a GUI may include “generate a story based on [content X].” An organization may use the term “story” in a proprietary context in a way that is distinct from the non-proprietary use of the term. The organization may refer to a set of related reconciliation tables used in a reconciliation platform as a “Story.” The system obtains mapping data that includes a mapping of the proprietary term “Story” to the non-proprietary terms “set of reconciliation tables.”

The mapping data may further include conditions. The conditions may tell the generative AI model whether the word(s) included in the request should be interpreted as proprietary content or non-proprietary content. For example, the mapping data may include a condition: “When [content X] specifies [data type Y], apply mapping of proprietary term to non-proprietary term. When [content X] specifies [data type Z], refrain from applying the mapping and use non-proprietary term.” When the system receives feedback (described below) associated with visualizations, the system may store the feedback as conditions to be applied to future requests that include a proprietary term.

Mapping data may also include attributes and characteristics. For example, a company may develop an offroad vehicle named “Grizzly.” Mapping data may include non-proprietary data describing the Grizzly, such as “4×4”, “offroad,” “vehicle”, and “4-seater.”

In one embodiment, the system stores a dictionary of proprietary reconciliation terms, mapping data associated with the proprietary reconciliation terms, and conditions for determining when to apply the mapping of proprietary reconciliation terms to non-proprietary reconciliation terms. Additionally, or alternatively, the system may parse proprietary content to identify mapping data. For example, a machine-learning model may identify a proprietary reconciliation term in a request directed to a generative AI model. The system may refer to a dictionary to determine if the proprietary reconciliation term is in the dictionary. If the term is in the dictionary, the system obtains a set of mapping data associated with the proprietary reconciliation term from the dictionary. However, if the term is not in the dictionary, the system accesses proprietary data sets to extract mapping data. The system may present a request to a user in a GUI for a data storage location from where the system may extract the mapping data.

The system may use a semantic analysis machine learning model to identify terms in the proprietary data that describe and/or define the proprietary reconciliation term. In one embodiment, the system adds the new proprietary reconciliation term and corresponding mapping data to the dictionary.

In one embodiment, a generative AI screening platform interposed between a user interface and a generative AI model accesses a set of proprietary data maintained by an entity to determine correlations between proprietary and non-proprietary concepts and terms. Proprietary data may include, for example, a listing of products offered by an entity or names for tasks in a project workflow. Tasks may include task descriptions. Based on the task descriptions, the generative AI screening platform may determine a non-proprietary task type. The generative AI screening platform may then map the non-proprietary task type to the proprietary reconciliation term included in the request to the generative AI model.

According to another example, the system may compare an example corresponding to a proprietary reconciliation term with non-proprietary examples to identify a relationship of a proprietary reconciliation term to a non-proprietary reconciliation term. For example, the system may identify the term “complete-o-meter” as a proprietary reconciliation term in a request to a generative AI model. The system may identify, in an entity's stored proprietary data, an image of a gauge graph corresponding to the description “complete-o-meter.” The system may determine the proprietary reconciliation term “complete-o-meter” corresponds to the non-proprietary reconciliation term gauge graph.

The system determines if criteria are met to apply a mapping of a proprietary reconciliation term to a non-proprietary term (Operation 712). Determining if the criteria are met may include analyzing the textual context of a term. For example, a request may include the words “generate a line graph showing the performance of silver and gold projects.” The system may identify Silver and Gold proprietary reconciliation terms within an organization that describe types of programs and projects being carried out by the organization. The system may determine that the mapping of the terms “Silver” and “Gold” to proprietary content is conditional on the terms being used to describe program development and completion. The system determines from the context of the request that the request is directed to programs being carried out by a company. Accordingly, the system applies the mapping of the proprietary reconciliation terms to a non-proprietary reconciliation term “program.” The mapping may further specify where the system should go to obtain information about the performance of the programs.

If the criteria are not met to apply a non-proprietary to proprietary mapping, the system proceeds to Operation 706 to generate a prompt based on the request, using the non-proprietary meaning of the terms. Referring to the example above where “Silver” and “Gold” refer to types of programs carried out by an organization, a request may include the terms “generate a bar graph of the price of gold for the past year.” The system determines that the term “gold” is not associated with programs, but rather with the metal. Accordingly, the system generates the prompt to the generative AI model without mapping the term “gold” to a non-proprietary reconciliation term “program”, and without enriching the prompt with proprietary contextual data in the prompt.

In one embodiment, determining if criteria are met to apply a mapping of proprietary reconciliation terms to non-proprietary may be based on specified criteria such as the criteria 124c-124n stored in the mapping 121 represented in FIG. 1D. These criteria may include whether specified terms are used in the same request as the proprietary reconciliation term or the identity of a user initiating a request. For example, if the system determines a user generating a request is not included in a set of criteria for applying a mapping, the system may execute the request without generating an enriched prompt including the mapping of proprietary reconciliation terms to non-proprietary terms. If the system determines a user generating a request is included in a set of criteria for applying the mapping, the system may execute the request by generating an enriched prompt including the mapping of proprietary reconciliation terms to non-proprietary reconciliation terms.

In another embodiment, determining if criteria are met to apply a mapping may be based on the output from a semantic machine learning model such as the semantic analysis model 115 represented in FIG. 1A. The semantic analysis model 115 may generate an embedding for tokens in a request. The embedding may include information representing whether or not to apply a mapping of proprietary reconciliation terms to non-proprietary reconciliation terms. Additionally, or alternatively, determining if criteria are met to apply a mapping may be based on the output from a classification-type machine learning model, such as the term classification model 116, represented in FIG. 1A. The system may be configured to apply a proprietary-to-non-proprietary mapping when the term classification model 116 classifies a term as “proprietary.”

If the system determines that criteria are met to apply a mapping of proprietary reconciliation terms to non-proprietary reconciliation terms, the system further identifies a proprietary storage location for proprietary content data (Operation 714). For example, if the proprietary reconciliation term corresponds to a program for rolling out a product, the system identifies data sets associated with the product. If the proprietary reconciliation term is a term used in business workflows, the system identifies the business workflows that reference the term. If the proprietary reconciliation term is a metric measuring performance of a set of time-series data, the system identifies the datasets that refer to the metric. Alternatively, the system may identify data sets of a type that the metric measures. In some embodiments, the system identifies the proprietary storage location based on location information stored in the mapping of proprietary to non-proprietary terms. Additionally, or alternatively, the system may access an application programming interface (API) configured to provide the system with proprietary content data.

The system generates an enriched generative AI prompt based on the request and the mapping of proprietary reconciliation terms to non-proprietary terms (Operation 716). The enriched generative AI prompt may further include proprietary content, such as tables, time-series data, and other descriptive data associated with proprietary reconciliation content. In an example where a proprietary reconciliation term describes a type of visualization, the enriched generative AI prompt may include data describing the visualization and/or an example of the visualization.

According to one example, the system generates an enriched generative AI prompt including (a) a set of instructions to output visualization content referencing proprietary reconciliation content, (b) mapping data describing a relationship of proprietary reconciliation terms to non-proprietary terms, and (c) datasets of characteristics of proprietary data. For example, the enriched generative AI prompt may specify that “The term [X] means [Y],” where X is a proprietary reconciliation term, and Y is a non-proprietary term. Additionally, or alternatively, the enriched generative AI prompt may specify that “The term [X] is a device with the following characteristics: A, B, C”, where A, B, and C describe non-proprietary characteristics of X.

The generative AI model generates a reconciliation visualization based on the request and the mapping of proprietary reconciliation terms to non-proprietary terms (Operation 718).

For example, the generative AI model trained on non-proprietary content uses the mapping data to identify a non-proprietary visualization associated with a proprietary reconciliation term in the request. The generative AI model identifies the visualization based on patterns learned during training on the non-proprietary content. For example, the mapping data may identify a proprietary reconciliation term as being an account type. The generative AI may identify a bipartite graph used to account types to a reconciliation metric. Additionally, or alternatively, the mapping data may identify proprietary data as corresponding to a category of invoices. The generative AI may identify a bar graph as displaying magnitude values for different categories. As another example, the mapping data may identify proprietary data as corresponding to a performance metric. The generative AI may identify a line graph as displaying performance metric values over time.

In some embodiments, the mapping data include data describing a correlation between a proprietary reconciliation term for a visualization and one or more non-proprietary visualizations. For example, the prompt “Create a reconciliation burn chart for the top 5 accounts by account balance for the ABC Co. XYZ Co. merger” references proprietary data associated with an event “ABC Co. XYZ Co. merger” as well as a proprietary name for a visualization “burn chart.” The mapping data includes a description of the term “burn chart” as a two-line graph comparing the total number of outstanding reconciliation tasks on a particular date versus the outstanding tasks.

In many instances, a generative AI model may identify multiple different visualizations that correspond to a particular set of proprietary data. The generative AI model determines a visualization to generate based on additional content in the enriched generative AI prompt. For example, one prompt may direct the generative AI model to generate a visualization of a performance metric over time. Another prompt may direct the generative AI model to generate a visualization comparing a performance metric for one period of time between two departments in an organization. The generative AI model identifies a first visualization corresponding to the first prompt and a second visualization corresponding to the second prompt. The system displays a visualization in a GUI based on the visualization content generated by the generative AI model.

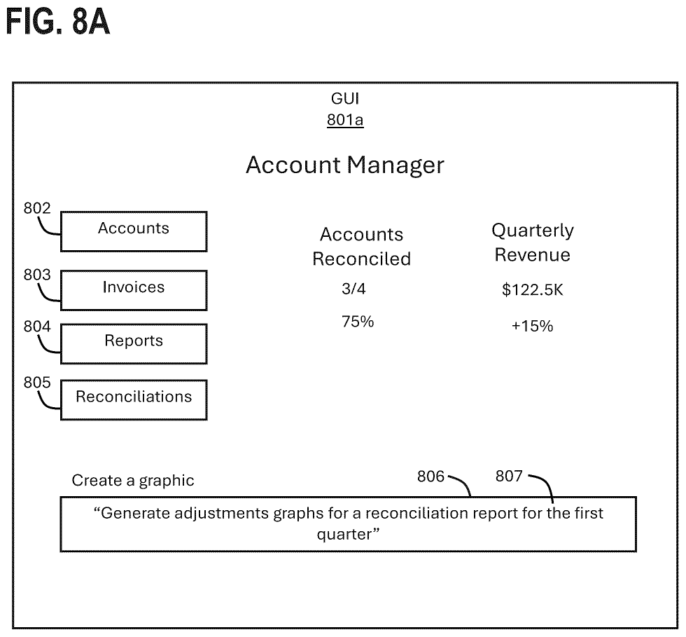

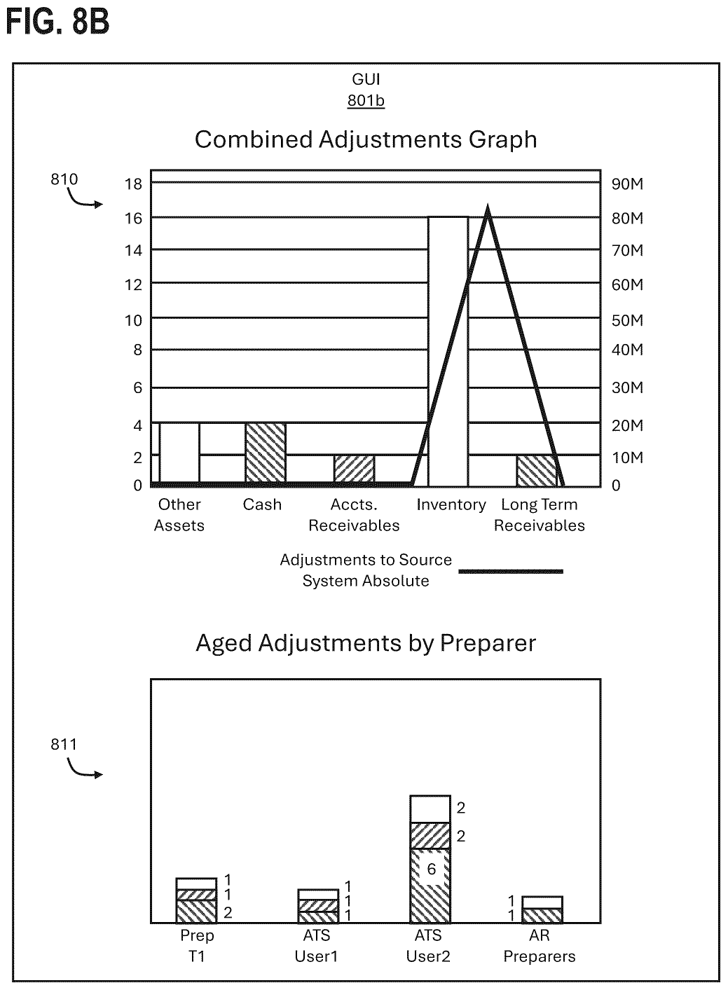

FIGS. 8A and 8B illustrates an example set of proprietary reconciliation graphs generated by a generative AI model using mappings of proprietary reconciliation terms to non-proprietary terms. In the example embodiment illustrated in FIG. 8A, a GUI 801a displays an account manager application display data. The GUI 801a includes an accounts button 802, an invoices button 803, a reports button 804, and a reconciliation button 805. The GUI 801a displays examples of key metrics data including accounts reconciled and quarterly revenue. The GUI 801a includes a text entry field 806. Entering text in the text entry field generates a request to a generative AI model to generate content. Since the GUI 801a presents reconciliation data, a system generates a prompt to the generative AI model that provides reconciliation context data to enable the generative AI model to generate the content.

A user enters a request 807 to “generate adjustments graphs for a reconciliation report for the first quarter.” The request includes terms that have non-proprietary and proprietary meanings, including “adjustment graphs” and “reconciliation report.” In particular, while adjustment graphs and reconciliation reports may be widely known, the generative AI model may not be trained to know the particular adjustment graphs that would be included in a particular reconciliation report for a particular company. Based on determining the terms “adjustment graphs” and reconciliation report” have proprietary meanings within a company, the system generates a prompt for the generative AI model that includes a mapping of the proprietary terms to non-proprietary content.

For example, the system determines that a reconciliation report refers to a set of two graphs. One graph is a graph that combines bar graph illustrating adjustments per account type with a line graph that represents an amount of adjustments to a source system record. Another graph illustrates a number of aged adjustments by particular users. The system reconciliation data, including adjustment data, from a location in memory pointed to by a mapping.

Based on the prompt that includes the mapping of proprietary terms to non-proprietary terms and content, the system presents GUI 801b including visualizations 810 and 811. Visualization 810 is a graph that combines a line graph with a bar graph to illustrate adjustments per account type and an amount of adjustments to a source system record. Visualization 811 is a bar graph illustrating aged adjustments by preparers.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes.

Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

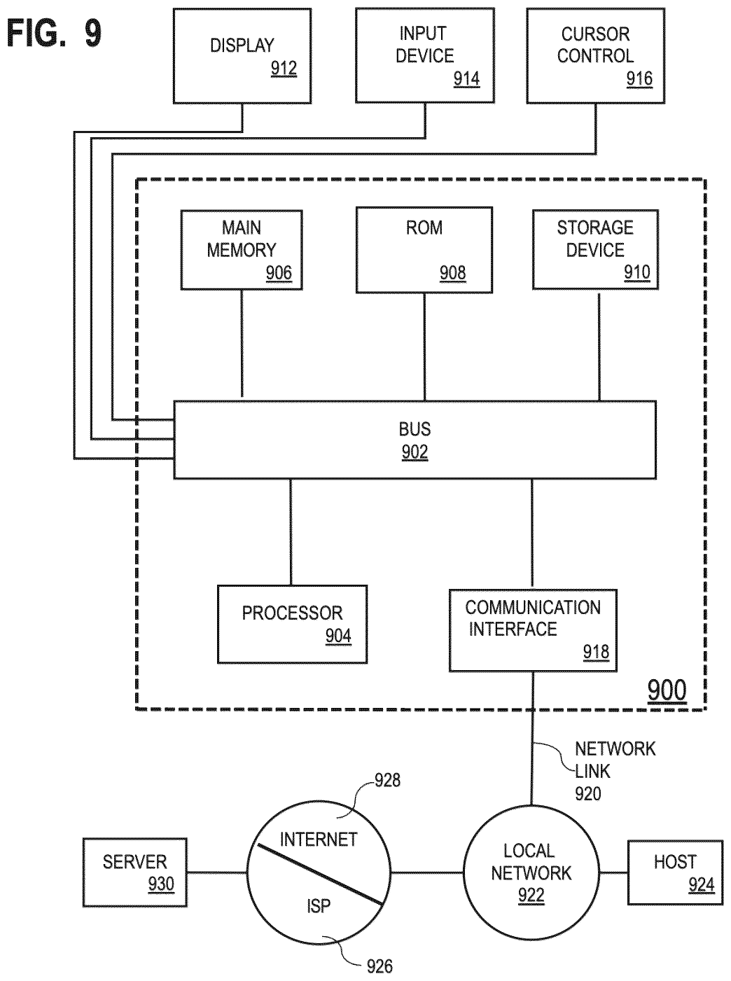

For example, FIG. 9 is a block diagram that illustrates a computer system 900 upon which an embodiment of the disclosure may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or a Solid State Drive (SSD) is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware, and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic, or optical signals that carry digital data streams representing distinct types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the worldwide packet data communication network now commonly referred to as the “Internet” 928. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

10. Miscellaneous; Extensions Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
detecting a request directed to a generative artificial intelligence (AI) model to generate a visualization in a graphical user interface (GUI) based on a first set of attributes associated with a first metric;
analyzing first content in the request to identify a first proprietary term associated with at least one of (a) the first metric and (b) the visualization;
accessing a first mapping of the first proprietary term to a first set of content;
generating a first prompt to the generative AI model to generate the visualization at least by:
including in the prompt the first mapping of the first proprietary term to the first set of content;
transmitting the first prompt to the generative AI model to obtain visualization content from the generative AI model, wherein the visualization content is based on the first mapping of the first proprietary term to the first set of content; and
responsive to the request, presenting a first visualization in the GUI based on the visualization content received from the generative AI model based on the first prompt.

2. The one or more non-transitory computer readable media of claim 1, wherein the first mapping of the first proprietary term to the first set of content includes a first mapping of the first proprietary term to a second set of non-proprietary terms.

3. The one or more non-transitory computer readable media of claim 2, wherein the first visualization includes: (a) a visualization shape based on the second set of non-proprietary terms, and (b) one or more labels specifying the first proprietary term.

4. The one or more non-transitory computer readable media of claim 1, wherein the first mapping of the first proprietary term to the first set of content includes a first mapping of the first proprietary term to a set of proprietary data corresponding to the first proprietary term.

5. The one or more non-transitory computer readable media of claim 1, wherein the first mapping of the first proprietary term to the first set of content includes a first mapping of the first proprietary term to a non-proprietary visualization type.

6. The one or more non-transitory computer readable media of claim 5, wherein the first visualization includes a visualization shape based on the non-proprietary visualization type.

7. The one or more non-transitory computer readable media of claim 1, wherein analyzing the first content in the request to identify the first proprietary term comprises:
applying a semantic machine learning model to the request, wherein the semantic machine learning model is trained to distinguish proprietary terms from non-proprietary terms.

8. The one or more non-transitory computer readable media of claim 7, wherein the operations further comprise:
identifying, by the semantic machine learning model, a second proprietary term in the request;
determining that the second proprietary term is not included in the first mapping; and
based on determining that the second proprietary term is not included in the mapping:
determining a second set of content to map to the second proprietary term; and
modifying the mapping to include a further mapping of the second set of content to the second proprietary term.

9. The one or more non-transitory computer readable media of claim 1, wherein the operations
further comprise:
identifying a set of criteria in the mapping,
wherein including the first mapping in the prompt of the first proprietary term to the first set of content is based at least on determining the request meets the set of criteria.

10. The one or more non-transitory computer readable media of claim 9, wherein determining the request meets the set of criteria comprises: determining at least one additional term in the request corresponds to a type specified in the set of criteria.

11. The one or more non-transitory computer readable media of claim 1, wherein the request is
directed to the generative AI model to generate a scheduling visualization based on the first set of attributes associated with the first metric, wherein the first metric is a first scheduling metric,
wherein the first content includes first scheduling content, the first proprietary term is a first proprietary scheduling term, and the first set of content includes a first set of scheduling content,
wherein the first mapping maps the first proprietary scheduling term to the first set of scheduling content,
wherein generating the first prompt comprises:
generating the first prompt to the generative AI model to generate the scheduling visualization at least by:
including in the prompt the first mapping of the first proprietary scheduling term to the first set of scheduling content,
wherein the visualization content is based on the first mapping of the first proprietary scheduling term to the first set of scheduling content, and
wherein presenting the first visualization in the GUI comprises presenting a first scheduling visualization in the GUI.

12. The one or more non-transitory computer readable media of claim 1, wherein the request is directed to the generative AI model to generate a reconciliation visualization based on the first set of attributes associated with the first metric, wherein the first metric is a first reconciliation metric,
wherein the first content includes first reconciliation content, the first proprietary term is a first proprietary reconciliation term, and the first set of content includes a first set of reconciliation content,
wherein the first mapping maps the first proprietary reconciliation term to the first set of reconciliation content,
wherein generating the first prompt comprises:
generating the first prompt to the generative AI model to generate the reconciliation visualization at least by:
including in the prompt the first mapping of the first proprietary reconciliation term to the first set of reconciliation content,
wherein the visualization content is based on the first mapping of the first proprietary reconciliation term to the first set of reconciliation content, and
wherein presenting the first visualization in the GUI comprises presenting a first reconciliation visualization in the GUI.

13. A method comprising:
detecting a request directed to a generative artificial intelligence (AI) model to generate a visualization in a graphical user interface (GUI) based on a first set of attributes associated with a first metric;
analyzing first content in the request to identify a first proprietary term associated with at least one of (a) the first metric and (b) the visualization;
accessing a first mapping of the first proprietary term to a first set of content;
generating a first prompt to the generative AI model to generate the visualization at least by:
including in the prompt the first mapping of the first proprietary term to the first set of content;
transmitting the first prompt to the generative AI model to obtain visualization content from the generative AI model, wherein the visualization content is based on the first mapping of the first proprietary term to the first set of content; and
responsive to the request, presenting a first visualization in the GUI based on the visualization content received from the generative AI model based on the first prompt.

14. The method of claim 13, wherein the first mapping of the first proprietary term to the first set of content includes a first mapping of the first proprietary term to a second set of non-proprietary terms.

15. The method of claim 14, wherein the first visualization includes: (a) a visualization shape based on the second set of non-proprietary terms, and (b) one or more labels specifying the first proprietary term.

16. The method of claim 13, wherein the first mapping of the first proprietary term to the first set of content includes a first mapping of the first proprietary term to a set of proprietary data corresponding to the first proprietary term.

17. The method of claim 13, wherein the first mapping of the first proprietary term to the first set of content includes a first mapping of the first proprietary term to a non-proprietary visualization type.

18. The method of claim 17, wherein the first visualization includes a visualization shape based on the non-proprietary visualization type.

19. The method of claim 13, wherein analyzing the first content in the request to identify the first proprietary term comprises:
applying a semantic machine learning model to the request, wherein the semantic machine learning model is trained to distinguish proprietary terms from non-proprietary terms.

20. A system comprising:
at least one device including a hardware processor;
the system being configured to perform operations comprising:
detecting a request directed to a generative artificial intelligence (AI) model to generate a visualization in a graphical user interface (GUI) based on a first set of attributes associated with a first metric;
analyzing first content in the request to identify a first proprietary term associated with at least one of (a) the first metric and (b) the visualization;
accessing a first mapping of the first proprietary term to a first set of content;
generating a first prompt to the generative AI model to generate the visualization at least by:
including in the prompt the first mapping of the first proprietary term to the first set of content;
transmitting the first prompt to the generative AI model to obtain visualization content from the generative AI model, wherein the visualization content is based on the first mapping of the first proprietary term to the first set of content; and
responsive to the request, presenting a first visualization in the GUI based on the visualization content received from the generative AI model based on the first prompt.
